(19) United States
(12) Patent Application Publication
(10) Pub. No.: US 2026/0079593 A1
(43) Pub. Date: Mar. 19, 2026

(54) DISPLAY PANEL AND DISPLAY APPARATUS

(71) Applicant: XIAMEN TIANMA DISPLAY TECHNOLOGY CO., LTD., Xiamen (CN)

(72) Inventors: Wenshuo LIN, Xiamen (CN); Huifang ZHOU, Xiamen (CN); Lilian KUANG, Xiamen (CN)

(21) Appl. No.: 19/393,314

(22) Filed: Nov. 18, 2025

(30) Foreign Application Priority Data
Sep. 18, 2024 (CN) 202411298710.7

(51) Int. Cl. G06F 3/041; G06F 3/044

(52) U.S. Cl. CPC G06F 3/0412; G06F 3/044

(57) ABSTRACT

Provided are a display panel and a display apparatus. The display panel includes a first touch electrode and a second touch electrode. The first touch electrode includes a first main body electrode and a first connection portion that are electrically connected. The first main body electrode and the second touch electrode are in a same layer, and the first connection portion and the second touch electrode are located in different layers. The display panel further includes a first dummy electrode. A first gap is provided between the first main body electrode and the second touch electrode. In a plan view, the first dummy electrode covers the first gap and overlaps with the first main body electrode and/or the second touch electrode.

### CROSS-REFERENCE TO RELATED APPLICATION

The present application claims priority to Chinese Patent Application No. 202411298710.7, filed on Sep. 18, 2024, the content of which is incorporated herein by reference in its entirety.

### TECHNICAL FIELD

The present application relates to the field of display technologies, and in particular, to a display panel and a display apparatus.

### BACKGROUND

In real life, display panels with touch function have gained increasingly widespread applications. In the field of display technologies, there are various methods for realizing touch-enabled display panels, such as the resistive film method, the optical sensing method, and the capacitive method. The capacitive method is further classified into the self-capacitance method and the mutual capacitance method. Among them, the mutual capacitance method has become a research focus due to its advantages including high sensitivity, fast response speed, and wide applicable size range.

### SUMMARY

In view of this, embodiments of the present application provide a display panel and a display apparatus to solve the above-mentioned problem.

In a first aspect, an embodiment of the present application provides a display panel, including a plurality of touch units, where a respective touch unit includes a first touch electrode and a second touch electrode, the first touch electrode includes a first main body electrode and a first connection portion, and in a same first touch electrode, two adjacent first main body electrodes are electrically connected through the first connection portion; and the first main body electrode and the second touch electrode are located in a same layer, and the first connection portion and the second touch electrode are located in different layers; and where the display panel further includes a dummy electrode, the dummy electrode includes a first dummy electrode, a first gap is provided between the first main body electrode and the second touch electrode, and in a plan view, the first dummy electrode covers the first gap and overlaps with the first main body electrode and/or the second touch electrode.

In a second aspect, an embodiment of the present application provides a display panel, including a plurality of touch units, where a respective touch unit includes a first touch electrode and a second touch electrode, the first touch electrode includes a first main body electrode and a first connection portion, and in a same first touch electrode, two adjacent first main body electrodes are electrically connected through the first connection portion; and the first main body electrode and the second touch electrode are in a same layer, and the first connection portion and the second touch electrode are located in different layers; and the display panel further includes a fourth sub-portion, the fourth sub-portion and the first connection portion are in a same layer, and the fourth sub-portion is grid-shaped; and the fourth sub-portion receives a fixed potential signal.

In a third aspect, an embodiment of the present application provides display panel, including a plurality of touch units, where a respective touch unit includes a first touch electrode and a second touch electrode, the first touch electrode includes a first main body electrode and a first connection portion, and in a same first touch electrode, two adjacent first main body electrodes are electrically connected through the first connection portion; the first main body electrode and the second touch electrode are in a same layer, and the first connection portion and the second touch electrode are located in different layers; where the display panel further includes a dummy electrode, the dummy electrode includes a first dummy electrode, a first gap is provided between the first main body electrode and the second touch electrode, and in a plan view, the first dummy electrode covers the first gap and overlaps with the first main body electrode and/or the second touch electrode; where a first sub-gap is provided between the first dummy portion and the first main body electrode, and a second sub-gap is provided between the first dummy portion and the second touch electrode; and where the first dummy electrode includes a first sub-portion and a first dummy portion, the first sub-portion and the first dummy portion are located in different layers, and in the plan view, the first sub-portion covers the first sub-gap and the second sub-gap, and the first sub-portion overlaps with the first main body electrode and/or the second touch electrode.

### BRIEF DESCRIPTION OF DRAWINGS

To more clearly illustrate the technical solutions of the embodiments of the present application, the accompanying drawings required in the embodiments will be briefly described below. Apparently, the accompanying drawings in the following description are merely some embodiments of the present application, and for those of ordinary skill in the art, other accompanying drawings can also be obtained based on these accompanying drawings without creative efforts.

FIG. 1 is a planar schematic diagram of a display panel according to an embodiment of the present application;

FIG. 2 is an enlarged schematic diagram of a touch unit according to an embodiment of the present application;

FIG. 3 is a cross-sectional schematic diagram taken along a section line A1A1′ in FIG. 2;

FIG. 4A is a cross-sectional schematic diagram taken along a section line A2A2′ in FIG. 2;

FIG. 4B is a cross-sectional schematic diagram taken along the section line A2A2′ in FIG. 2;

FIG. 5 is an enlarged schematic diagram of a region Q1 in FIG. 2;

FIG. 5A is a schematic diagram of a first sub-portion in FIG. 5;

FIG. 6 is another enlarged schematic diagram of the region Q1 in FIG. 2;

FIG. 6A is a schematic diagram of a first sub-portion in FIG. 6;

FIG. 7 is another enlarged schematic diagram of the region Q1 in FIG. 2;

FIG. 8 is a cross-sectional schematic diagram taken along a section line A2A2′ in FIG. 7;

FIG. 9A is an enlarged schematic diagram of a position where a first dummy electrode is adjacent to a first main body electrode according to an embodiment of the present application;

FIG. 9B is an enlarged schematic diagram of a position where a first dummy electrode is adjacent to a second touch electrode according to an embodiment of the present application;

FIG. 10 is an enlarged schematic diagram at Q2 in FIG. 2;

FIG. 11 is a cross-sectional schematic diagram taken along a section line A3A3′ in FIG. 10;

FIG. 12A is an enlarged schematic diagram of a region Q3 in FIG. 2;

FIG. 12B is an enlarged schematic diagram of a region Q4 in FIG. 2;

FIG. 12C is a schematic diagram of a second sub-portion in FIGS. 12A and 12B;

FIG. 13A is a cross-sectional schematic diagram taken along a section line A4A4′ in FIG. 12A;

FIG. 13B is a cross-sectional schematic diagram taken along a section line A4A4′ in FIG. 12B;

FIG. 14A is another enlarged schematic diagram of the region Q3 in FIG. 2;

FIG. 14B is another enlarged schematic diagram of the region Q4 in FIG. 2;

FIG. 14C is a schematic diagram of a second sub-portion in FIGS. 14A and 14B;

FIG. 15 is another enlarged schematic diagram of the region Q3 in FIG. 2;

FIG. 16 is a cross-sectional schematic diagram taken along a section line A5A5′ in FIG. 15;

FIG. 17 is another enlarged schematic diagram of the region Q3 in FIG. 2;

FIG. 18 is a cross-sectional schematic diagram taken along a section line A6A6′ in FIG. 17;

FIG. 19 is an enlarged schematic diagram of a region Q5 in FIG. 2;

FIG. 20 is a cross-sectional schematic diagram taken along a section line A7A7′ in FIG. 19;

FIG. 21 is another cross-sectional schematic diagram taken along the section line A1A1′ in FIG. 2;

FIG. 22 is a partially enlarged schematic diagram of a fourth sub-portion according to an embodiment of the present application;

FIG. 23 is a planar schematic diagram of another display panel according to an embodiment of the present application;

FIG. 24 is a planar schematic diagram of another display panel according to an embodiment of the present application;

FIG. 25 is a planar schematic diagram of another display panel according to an embodiment of the present application;

FIG. 26 is a partially enlarged diagram of a first bezel area in FIG. 25;

FIG. 27 is a partially enlarged diagram of a second bezel area in FIG. 25;

FIG. 28 is a partially enlarged schematic diagram of a first region in FIG. 25;

FIG. 29 is a partially enlarged schematic diagram of a second region in FIG. 25;

FIG. 30A is a partially enlarged schematic diagram of a first main body electrode according to an embodiment of the present application;

FIG. 30B is a partially enlarged schematic diagram of a second touch electrode according to an embodiment of the present application;

FIG. 31 is a partial structural schematic diagram of a display panel according to an embodiment of the present application;

FIG. 32 is a partial structural schematic diagram of another display panel according to an embodiment of the present application; and

FIG. 33 is a schematic diagram of a display apparatus according to an embodiment of the present application.

### DESCRIPTION OF EMBODIMENTS

In order to better understand the technical solutions of the present application, the embodiments of the present application are described in detail below with reference to the accompanying drawings.

It should be clear that the described embodiments are merely a part of the embodiments of the present application, not all of them. Based on the embodiments in the present application, all other embodiments obtained by a person of ordinary skill in the art without creative efforts fall within the protection scope of the present application.

The terms used in the embodiments of the present application are merely for the purpose of describing specific embodiments, and are not intended to limit the present application. The singular forms “a/an”, “the”, and “said” used in the embodiments and the appended claims of the present application are also intended to include the plural forms, unless the context clearly indicates otherwise.

It should be understood that the term “and/or” used herein is merely a way of describing an associative relationship between associated objects, indicating that there may be three types of relationships. For example, A and/or B may indicate three scenarios: A exists alone, both A and B exist, and B exists alone. In addition, the character “/” herein generally indicates that the associated objects before and after it have an “or” relationship.

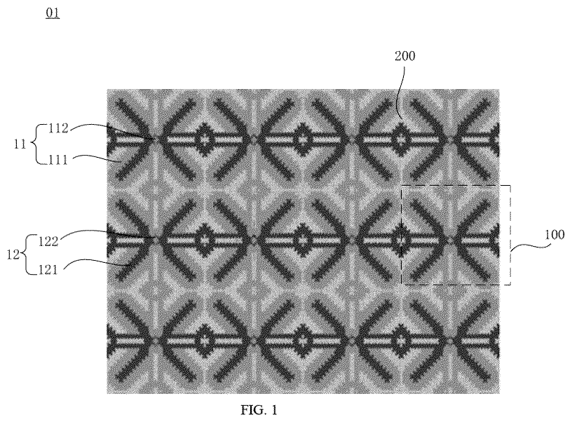

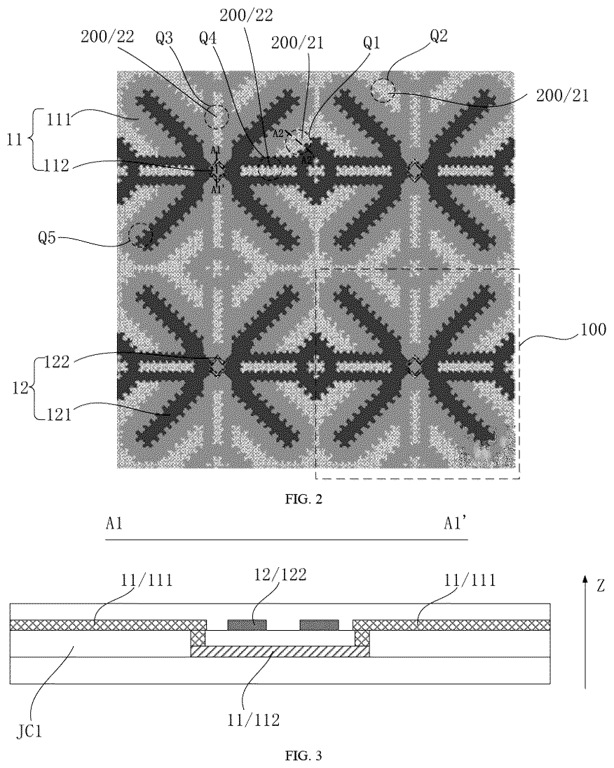

FIG. 1 is a planar schematic diagram of a display panel according to an embodiment of the present application. FIG. 2 is an enlarged schematic diagram of a touch unit according to an embodiment of the present application.

An embodiment of the present application provides a display panel 01. As shown in FIGS. 1 and 2, the display panel 01 includes a plurality of touch units 100. Each touch unit 100 includes a first touch electrode 11 and a second touch electrode 12. The first touch electrode 11 is electrically insulated from the second touch electrode 12.

In the display panel 01, the touch units 100 may be arranged in an array along a row direction and a column direction. For a plurality of touch units 100 arranged along the column direction, the first touch electrodes 11 in the touch units 100 may be electrically connected in sequence. For a plurality of touch units 100 arranged along the row direction, the second touch electrodes 12 in the touch units 100 may be electrically connected in sequence. When a user touches the display panel 01, a control system can calculate the coordinates of the touch point according to the magnitude of the mutual capacitance between the first touch electrode 11 and the second touch electrode 12 in the touch unit 100.

The first touch electrode 11 includes a first main body electrode 111 and a first connection portion 112. In a same first touch electrode 11, two adjacent first main body electrodes 111 are electrically connected through the first connection portion 112.

Exemplarily, as shown in FIG. 2, one first touch electrode 11 may include two first main body electrodes 111 and a first connection portion 112 connecting the two first main body electrodes 111.

The second touch electrode 12 includes a second main body electrode 121 and a second connection portion 122. In a same second touch electrode 12, two adjacent second main body electrodes 121 are electrically connected through the second connection portion 122.

Exemplarily, as shown in FIG. 2, one second touch electrode 12 may include two second main body electrodes 121 and a second connection portion 122 connecting the two second main body electrodes 121.

As shown in FIG. 3, FIG. 3 is a cross-sectional schematic diagram taken along a section line A1A1′ in FIG. 2. In a first direction Z or a plane view, the first connection portion 112 overlaps with the second touch electrode 12. The first direction Z is perpendicular to a plane of the display panel 01.

Exemplarily, the second main body electrode 121 and the second connection portion 122 are located in a same layer. The first main body electrode 111 and the second touch electrode 12 are located in a same layer. The first connection portion 112 and the second touch electrode 12 are located in different layers. That is, the first main body electrode 111 and the first connection portion 112 are located in different layers.

Optionally, the first connection portion 112 is located on a side of the first main body electrode 111 away from a light-exiting surface of the display panel 01.

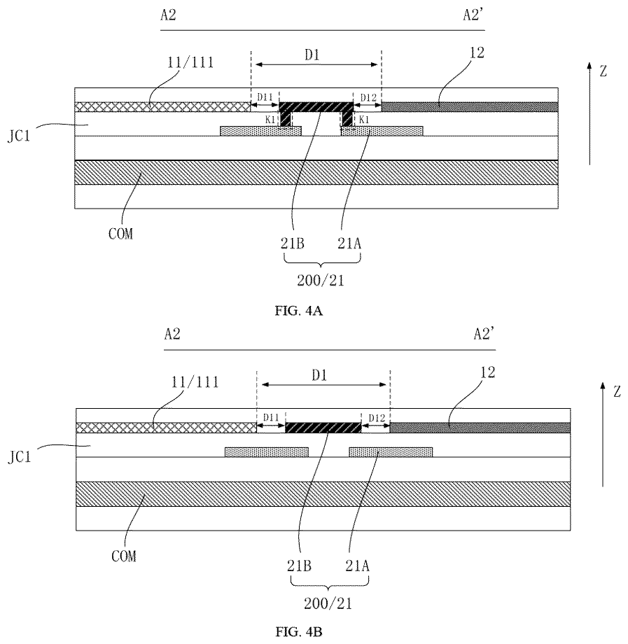

As shown in FIGS. 1 to 4B, FIG. 4A is a cross-sectional schematic diagram taken along a section line A2A2′ in FIG. 2, and FIG. 4B is a cross-sectional schematic diagram taken along the section line A2A2′ in FIG. 2. The display panel 01 further includes a dummy electrode 200 located on a side of a display cathode COM of the display panel 01 facing the light-exiting surface of the display panel 01. The dummy electrode 200 includes a first dummy electrode 21. A first gap D1 is included between the first main body electrode 111 and the second touch electrode 12 in the same layer. In the plane view Z, the first dummy electrode 21 covers the first gap D1 and overlaps with the first main body electrode 111 and/or the second touch electrode 12. That is, in the plane view, at least one of the first main body electrode 111 and the second touch electrode 12 overlaps with the first dummy electrode 21.

It should be noted that FIGS. 4A-4B only illustrate a case where the first dummy electrode 21 overlaps with the first main body electrode 111 and overlaps with the second touch electrode 12.

In the embodiment of the present application, by arranging the first dummy electrode 21 to cover the first gap D1 in the plane view, when the display panel 01 displays an image, the first dummy electrode 21 can block the light leakage in the first gap D1, which is conducive to avoiding the problem of the first gap D1 being visible in the displayed image, thereby being conducive to improving the display quality of the display panel 01.

Meanwhile, arranging the first dummy electrode 21 to overlap with the first main body electrode 111 and/or the second touch electrode 12 in the plane view is conducive to avoiding the problem of poor reliability of the first dummy electrode 21 in covering the first gap D1 caused by process variations, and is conducive to enhancing the reliability of the first dummy electrode 21 in covering the first gap D1, thereby further being conducive to avoiding the problem of the first gap D1 being visible in the displayed image.

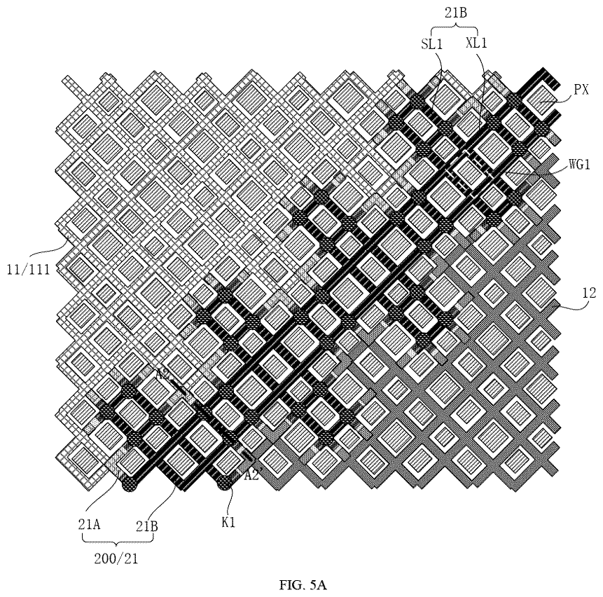

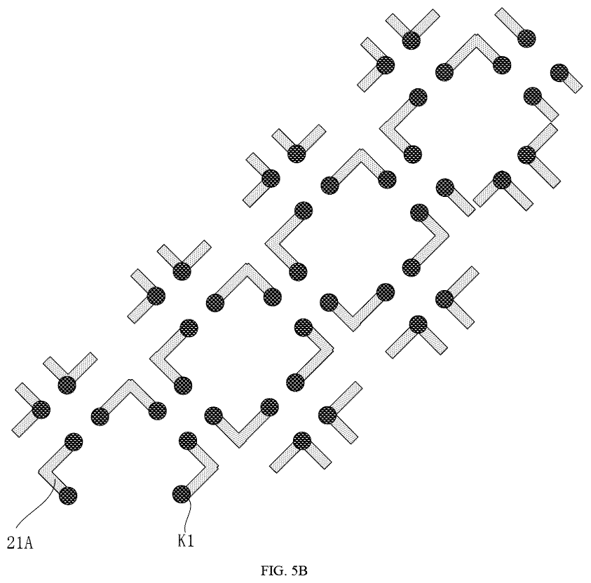

FIG. 5 is an enlarged schematic diagram of a region Q1 in FIG. 2.

In one technical solution of the embodiment of the present application, as shown in FIG. 4A, the first dummy electrode 21 includes a first sub-portion 21A and a first dummy portion 21B that are connected. The first dummy portion 21B is in a same layer as the first main body electrode 111 and is located in the first gap D1. A first sub-gap D11 is provided between the first dummy portion 21B and the first main body electrode 111, and a second sub-gap D12 is provided between the first dummy portion 21B and the second touch electrode 12.

Exemplarily, as shown in FIGS. 2, 4A to 4B, and 5, the section line A2A2′ in FIG. 5 is an enlarged illustration of the section line A2A2′ in FIG. 2. The first dummy portion 21B, the first main body electrode 111, and the second touch electrode 12 are all grid-shaped. The first sub-gap D11 between the first dummy portion 21B and the first main body electrode 111 may be a gap between one trace in the first dummy portion 21B and one trace in the first main body electrode 111, and a plurality of first sub-gaps D11 may be provided between the first dummy portion 21B and the first main body electrode 111. The second sub-gap D12 between the first dummy portion 22B and the second touch electrode 12 may be a gap between one trace in the first dummy portion 21B and one trace in the second touch electrode 12, and a plurality of second sub-gaps D12 may be provided between the first dummy portion 21B and the second touch electrode 12.

The first sub-portion 21A and the first dummy portion 21B are located in different layers. In the plane view, the first sub-portion 21A covers the first sub-gap D11 and the second sub-gap D12, and overlaps with the first main body electrode 111 and/or the second touch electrode 12. That is, in the plane view, at least one of the first main body electrode 111 and the second touch electrode 12 overlaps with the first sub-portion 21A.

In this technical solution, by arranging the first dummy portion 21B to be in the same layer as the first main body electrode 111 and located in the first gap D1 between the first main body electrode 111 and the second touch electrode 12, the first dummy portion 21B can fill part of the first gap D1. Meanwhile, by arranging the first sub-portion 21A to cover the first sub-gap D11 between the first dummy portion 21B and the first main body electrode 111, and the second sub-gap D12 between the first dummy portion 21B and the second touch electrode 12, the first dummy electrode 21 can cover the first gap D1.

Moreover, the sizes of the first sub-gap D11 and the second sub-gap D12 are smaller than the size of the first gap D1, which is conducive to reducing the process difficulty of the first sub-portion 21A covering the first sub-gap D11 and the second sub-gap D12.

Optionally, the first sub-portion 21A is in the same layer as the first connection portion 112. As such, the first sub-portion 21A can be manufactured using the same process and material as the first connection portion 112, which neither requires adding an additional process for manufacturing the first sub-portion 21A nor increases the thickness of the display panel 01.

In one implementation of this technical solution, as shown in FIG. 4A, a first insulating layer JC1 is provided between the first sub-portion 21A and the first dummy portion 21B. The first insulating layer JC1 includes a first through hole K1, and the first sub-portion 21A is connected to the first dummy portion 21B through the first through hole K1.

Optionally, as shown in FIG. 5, the display panel 01 further includes a plurality of sub-pixels PX. The first dummy portion 21B includes a plurality of first type-A traces SL1 and a plurality of first type-B traces XL1 that are connected, and an extending direction of the first type-A traces SL1 and an extending direction of the first type-B traces XL1 intersect with each other.

The plurality of first type-A traces SL1 and the plurality of first type-B traces XL1 cross to define at least one first dummy grid WG1. In the plane view, the first dummy grid WG1 encloses at least one sub-pixel PX. The first through hole K1 is located at the intersection of the first dummy grid WG1.

Based on this arrangement, in the plane view, there is no overlap between the first dummy portion 21B and the sub-pixels PX, which is conducive to avoiding the first dummy portion 21B blocking the light exiting of the sub-pixels PX. Moreover, the intersections of the first dummy grid WG1 are usually far from the sub-pixels PX they enclose. Arranging the first through hole K1 at the intersections of the first dummy grid WG1 is conducive to reducing the impact of the fabrication of the first through hole K1 on the sub-pixels PX, thereby being conducive to reducing the impact of the fabrication of the first through hole K1 on the display effect.

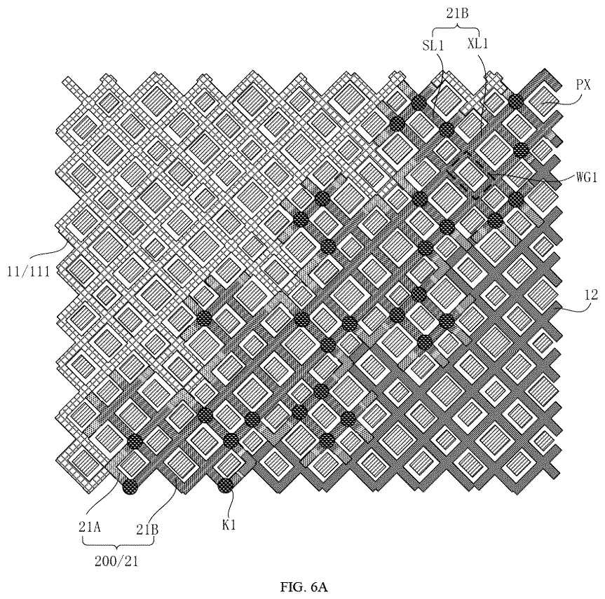

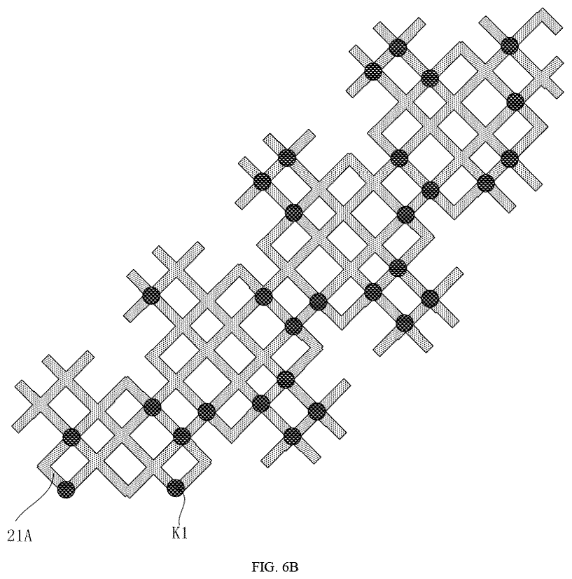

Optionally, as shown in FIGS. 5 and 6, FIG. 6 is another enlarged schematic diagram of the region Q1 in FIG. 2. In the plane view, the first sub-portion 21A overlaps with the first dummy portion 21B, and a projection of the first sub-portion 21A onto a plane of the first dummy portion 21B lies on the first dummy grid WG1. The first sub-portion 21A may overlap with at least a part of the first dummy portion 21B. As such, on one hand, there is no overlap between the first sub-portion 21A and the sub-pixels PX in the plane view, which is conducive to avoiding the first sub-portion 21A blocking the light exiting of the sub-pixels PX; on the other hand, the structural complexity of the first dummy electrode 21 can be reduced, thereby reducing the manufacturing difficulty of the first dummy electrode 21.

Exemplarily, as shown in FIG. 6 and FIG. 6A, FIG. 6A is a schematic diagram of a first sub-portion in FIG. 6, the first dummy electrode 21 includes one first sub-portion 21A, which is connected to the first dummy portion 21B through at least one first through hole K1. In this case, in the plane view, the projection of the first sub-portion 21A onto a region of the first dummy portion 21B may coincide with the first dummy portion 21B.

Exemplarily, as shown in FIGS. 5 and 5A, FIG. 5A is a schematic diagram of a first sub-portion in FIG. 5. The first dummy electrode 21 includes a plurality of first sub-portions 21A, and one first sub-portion 21A is connected to the first dummy portion 21B through at least one first through hole K1. As shown in FIG. 5A, the first sub-portion 21A may be in the shape of “-”, “ [symbol] ”, “ [symbol] ”, or “ [symbol] ”, or a combination of at least two of “-”, “ [symbol] ”, ‘ [symbol] ’, and “ [symbol] ”.

It should be noted that FIG. 5A only illustrates a case where the first sub-portion 21A is in the shape of “ [symbol] ” and “-”, and is connected to the first dummy portion 21B through one or two first through holes K1.

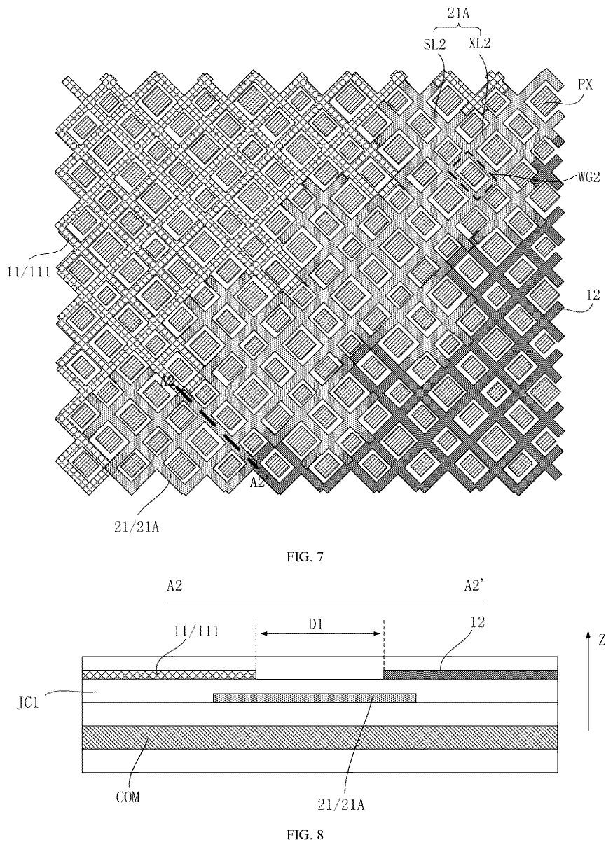

FIG. 7 is another enlarged schematic diagram of the region Q1 in FIG. 2, and FIG. 8 is a cross-sectional schematic diagram taken along a section line A2A2′ in FIG. 7.

In another technical solution of the embodiment of the present application, as shown in FIGS. 7 and 8, the first dummy electrode 21 includes a first sub-portion 21A, and the first sub-portion 21A and the first main body electrode 111 are located in different layers. In the plane view, the first sub-portion 21A covers the first gap D1, and overlaps with the first main body electrode 111 and/or the second touch electrode 12. That is, in the plane view, at least one of the first main body electrode 111 and the second touch electrode 12 overlaps with the first sub-portion 21A.

Exemplarily, as shown in FIG. 8, the first sub-portion 21A, the first main body electrode 111, and the second touch electrode 12 are all grid-shaped. The first sub-portion 21A overlapping with the first main body electrode 111 means that one trace in the first sub-portion 21A overlaps with one trace in the first main body electrode 111. The first sub-portion 21A overlapping with the second touch electrode 12 means that one trace in the first sub-portion 21A overlaps with one trace in the second touch electrode 12.

It should be noted that FIG. 8 only illustrates a case where the first sub-portion 21A overlaps with the first main body electrode 111 and also overlaps with the second touch electrode 12, and the section line A2A2′ in FIG. 8 is an enlarged illustration of the section line A2A2′ in FIG. 2.

In this technical solution, the first dummy electrode 21 has a single-layer structure. By arranging the first sub-portion 21A of the first dummy electrode 21 to cover the first gap D1, the first dummy electrode 21 can cover the first gap D1. Moreover, the first dummy electrode 21 having a single-layer structure is conducive to reducing the structural complexity of the first dummy electrode 21, thereby being conducive to reducing the manufacturing difficulty of the first dummy electrode 21.

Optionally, the first sub-portion 21A is in a same layer as the first connection portion 112. As such, the first sub-portion 21A can be manufactured using the same process and material as the first connection portion 112, which neither requires adding an additional process for manufacturing the first sub-portion 21A nor increases the thickness of the display panel 01.

Optionally, as shown in FIG. 7, the display panel 01 further includes a plurality of sub-pixels PX. The first sub-portion 21A includes a plurality of second type-A traces SL2 and a plurality of second type-B traces XL2 that are connected, and a extending direction of the second type-A traces SL2 and a extending direction of the second type-B traces XL2 intersect with each other.

The plurality of second type-A traces SL2 and the plurality of second type-B traces XL2 cross to define at least one second dummy grid WG2. In the plane view, the second dummy grid WG2 encloses at least one sub-pixel PX.

Based on this arrangement, in the plane view, there is no overlap between the first sub-portion 21A and the sub-pixels PX, that is, no overlap between the first dummy electrode 21 and the sub-pixels PX, which is conducive to avoiding the first dummy electrode 21 blocking the light exiting of the sub-pixels PX.

In an embodiment of the present application, as shown in FIGS. 5, 6, and 7, in the plane view, the first dummy electrode 21 is grid-shaped, and both the first main body electrode 111 and the second touch electrode 12 are grid-shaped.

Taking FIG. 7 as an example, in the plane view, the first dummy electrode 21, first main body electrode 111 and the second touch electrode 12 may form a grid structure. That is, the entire structure composed of the first dummy electrode 21, first main body electrode 111 and the grid-shaped second touch electrode 12 is still grid-shaped.

At a position where the first main body electrode 111 is close to the orthographic projection of the first dummy electrode 21 onto the plane of the first main body electrode 111, one grid in the grid structure WG may be jointly defined by the cross of a trace in the first main body electrode 111 and a trace in the orthographic projection of the first dummy electrode 21 onto the plane of the first main body electrode 111.

At a position where the second touch electrode 12 is close to the orthographic projection of the first dummy electrode 21 onto the plane of the first main body electrode 111, one grid in the grid structure WG may be jointly defined by the cross of a trace in the second touch electrode 12 and a trace in the orthographic projection of the first dummy electrode 21 onto the plane of the first main body electrode 111.

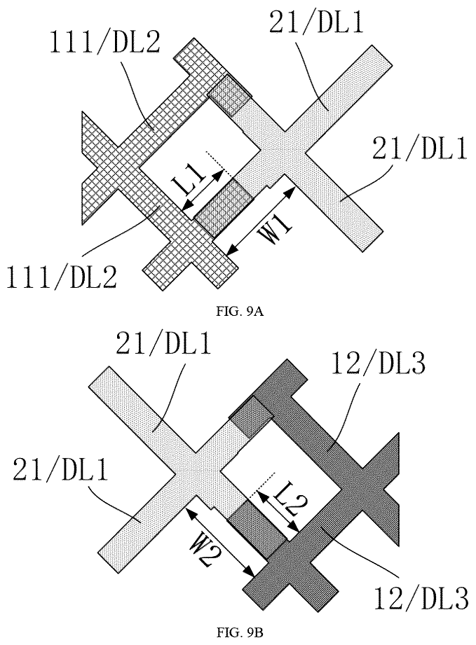

FIG. 9A is an enlarged schematic diagram of a position where a first dummy electrode is adjacent to a first main body electrode according to an embodiment of the present application, and FIG. 9B is an enlarged schematic diagram of a position where a first dummy electrode is adjacent to a second touch electrode according to an embodiment of the present application.

As shown in FIGS. 9A and 9B, the orthographic projection of the first dummy electrode 21 onto the plane of the first main body electrode 111 includes a plurality of first traces DL1 forming a grid structure, and the plurality of first traces DL1 may cross each other to form a grid shape. The first main body electrode 111 includes a plurality of second traces DL2 forming a grid structure, and the plurality of second traces DL2 may cross each other to form a grid shape. The second touch electrode 12 includes a plurality of third traces DL3 forming a grid structure, and the plurality of third traces DL3 may cross each other to form a grid shape.

Herein, as shown in FIG. 9A, in the plane view, the first traces DL1 overlap with the second traces DL2, and an overlap length L1 between one first trace DL1 and one second trace DL2 is not greater than a side length W1 of a grid in the grid structure, i.e., L1≤W1. Herein, the grid with the side length W1 may refer to a grid jointly defined by the cross of the first traces DL1 and the second traces DL2.

And/or, as shown in FIG. 9B, in the plane view, the first traces DL1 overlap with the third traces DL3, and an overlap length L2 between one first trace DL1 and one third trace DL3 is not greater than a side length W2 of a grid in the grid structure, i.e., L2≤W2. Herein, the grid with the side length W2 may refer to a grid jointly defined by the cross of the first traces DL1 and the third traces DL3.

That is to say, when the first dummy electrode 21 overlaps with the first main body electrode 111, it may mean that the first traces DL1 in the first dummy electrode 21 overlap with the second traces DL2 in the first main body electrode 111, and the overlap length L1 between one first trace DL1 and one second trace DL2 is not greater than the side length W1 of a grid. Of course, there may be a plurality of first traces DL1 and second traces DL2 that overlap correspondingly.

When the first dummy electrode 21 overlaps with the second touch electrode 12, it may mean that the first traces DL1 in the first dummy electrode 21 overlap with the third traces DL3 in the second touch electrode 12, and the overlap length L2 between one first trace DL1 and one third trace DL3 is not greater than the side length W2 of a grid. Of course, there may be a plurality of first traces DL1 and third traces DL3 that overlap correspondingly.

In the embodiment of the present application, setting the overlap length L1 between one first trace DL1 and one second trace DL2 within a certain range, and/or setting the overlap length L2 between one first trace DL1 and one third trace DL3 within a certain range, while ensuring that the first dummy electrode 21 effectively covers the first gap D1, are conducive to avoiding excessive overlap between the first dummy electrode 21 and the first main body electrode 111, and/or excessive overlap between the first dummy electrode 21 and the second touch electrode 12, thereby being conducive to avoiding the generation of a large coupling capacitance between the first dummy electrode 21 and the first main body electrode 111 and/or the second touch electrode 12, which would affect the potentials of the first main body electrode 111 and/or the second touch electrode 12, and further being conducive to reducing the impact of the first dummy electrode 21 on touch accuracy.

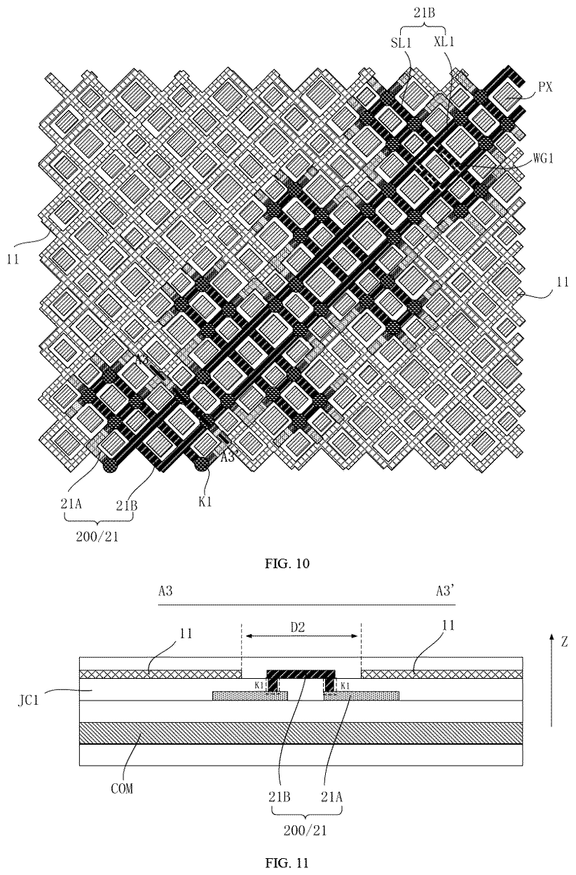

FIG. 10 is an enlarged schematic diagram at Q2 in FIG. 2, and FIG. 11 is a cross-sectional schematic diagram taken along a section line A3A3′ in FIG. 10.

In an embodiment of the present application, as shown in FIGS. 2, 10, and 11, the second gap D2 is provided between at least one pair of two adjacent first touch electrodes 11 and two adjacent second touch electrodes 1. That is to say, the second gap D2 may be provided between the two adjacent first touch electrodes 11, and/or the second gap D2 may be provided between the two adjacent second touch electrodes 12. FIG. 2 illustrates an example where the second gap D2 is provided between the two adjacent first touch electrodes 11.

Herein, as shown in FIG. 11, in the plane view, the first dummy electrode 21 covers the second gap D2.

Optionally, in the plane view, the first dummy electrode 21 overlaps with at least one of the two adjacent first touch electrodes 11 between which the second gap D2 is provided, so as to ensure the reliability of the first dummy electrode 21 covering the second gap D2. Of course, for a case where the second gap D2 is provided between two adjacent second touch electrodes 12, the first dummy electrode 21 may also overlap with at least one of the two adjacent second touch electrodes 12 between which the second gap D2 is provided.

Exemplarily, as shown in FIG. 2, the part of the first dummy electrode 21 covering the second gap D2 is connected to the part covering the first gap D1.

Exemplarily, the structure of the part of the first dummy electrode 21 covering the second gap D2 may be the same as the structure of the part covering the first gap D1. For example, both the part of the first dummy electrode 21 covering the second gap D2 and the part covering the first gap D1 are single-layer structures including the first sub-portion 21A. Or both the part of the first dummy electrode 21 covering the second gap D2 and the part covering the first gap D1 are double-layer structures including the first sub-portion 21A and the first dummy portion 21B.

Of course, the structure of the part of the first dummy electrode 21 covering the second gap D2 may also be different from the structure of the part covering the first gap D1. For example, the part of the first dummy electrode 21 covering the first gap D1 is a double-layer structure, and the part of the first dummy electrode 21 covering the second gap D2 is a single-layer structure.

In the embodiment of the present application, the first dummy electrode 21 may further cover the second gap D2 in the plane view. Then, when the display panel 01 displays an image, the first dummy electrode 21 may also block the light leakage in the second gap D2, which is conducive to avoiding the problem of the visibility of the second gap D2 in the displayed image, thereby further being conducive to improving the display quality of the display panel 01.

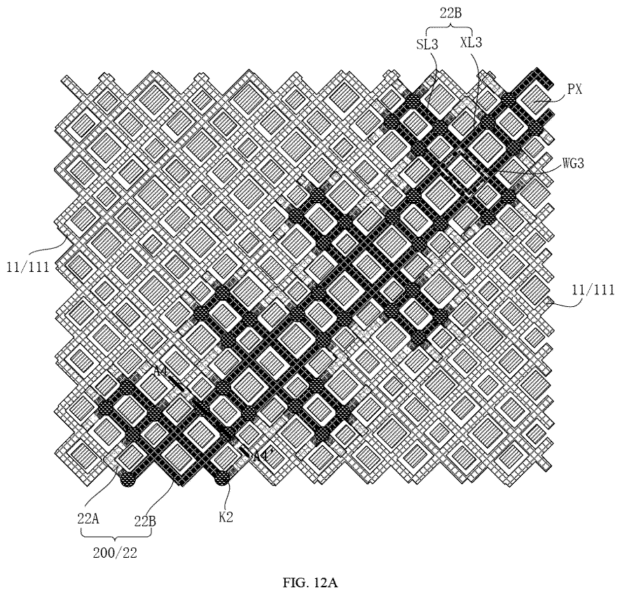

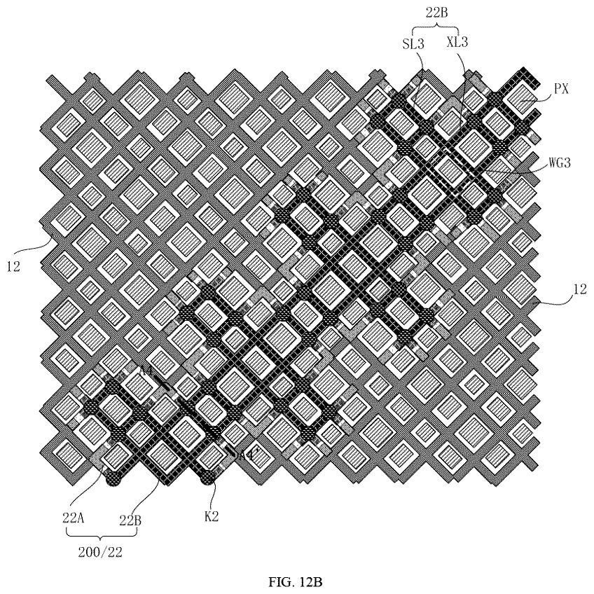

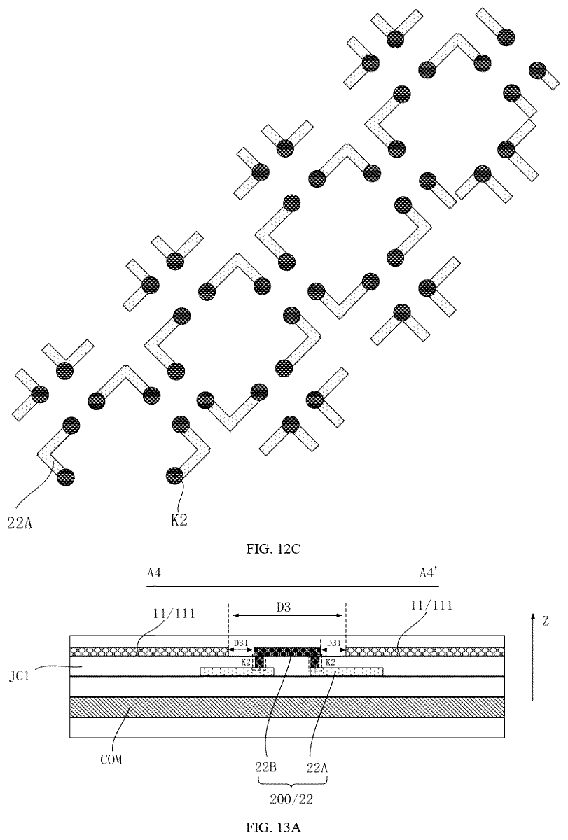

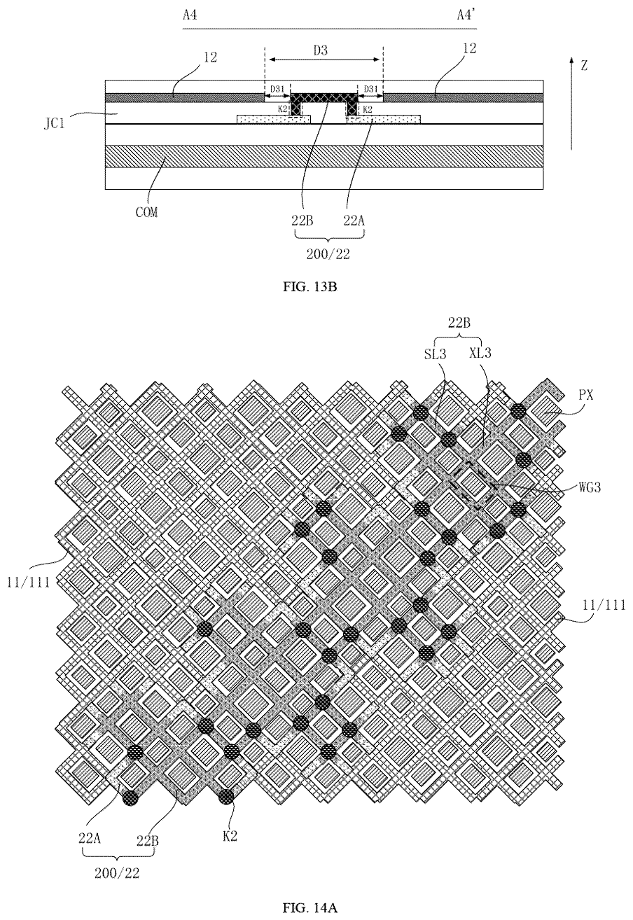

FIG. 12A is an enlarged schematic diagram of a region Q3 in FIG. 2, FIG. 12B is an enlarged schematic diagram of a region Q4 in FIG. 2, FIG. 13A is a cross-sectional schematic diagram taken along a section line A4A4′ in FIG. 12A, and FIG. 13B is a cross-sectional schematic diagram taken along a section line A4A4′ in FIG. 12B.

In an embodiment of the present application, both the first touch electrode 11 and the second touch electrode 12 are grid-shaped. As shown in FIGS. 2, 12A, and 13A, or as shown in FIGS. 2, 12B, and 13B, the first touch electrode 11 and/or the second touch electrode 12 includes a third gap D3. The third gap D3 may be located in the first main body electrode 111 of the first touch electrode 11 and/or in the second main body electrode 121 of the second touch electrode 12. A length of the third gap D3 is greater than the side length of a grid.

It should be noted that FIG. 2 only illustrates a case where both the first touch electrode 11 and the second touch electrode 12 include the third gap D3.

Due to the fact that both the first touch electrode 11 and the second touch electrode 12 are grid-shaped, as shown in FIGS. 12A and 13A, when the third gap D3 is located in the first touch electrode 11, the third gap D3 may refer to a gap between one trace and another trace in the first touch electrode 11. The length of the gap is greater than the side length of a grid in the first touch electrode 11, and the first touch electrode 11 may include a plurality of third gaps D3. As shown in FIGS. 12B and 13B, when the third gap D3 is located in the second touch electrode 12, the third gap D3 may refer to a gap between one trace and another trace in the second touch electrode 12. The length of the gap is greater than the side length of a grid in the second touch electrode 12, and the second touch electrode 12 may include a plurality of third gaps D3.

The dummy electrode 200 further includes a second dummy electrode 22. As shown in FIGS. 13A and 13B, in the plane view, the second dummy electrode 22 covers the third gap D3.

When both the first touch electrode 11 and the second touch electrode 12 include the third gap D3, the second dummy electrode 22 covering the third gap D3 in the first touch electrode 11 and the second dummy electrode 22 covering the third gap D3 in the second touch electrode 12 may be separated from each other.

Optionally, in the plane view, the second dummy electrode 22 overlaps with at least one of the two traces between which the third gap D3 is provided, so as to ensure the reliability of the second dummy electrode 22 covering the third gap D3.

In the embodiment of the present application, the provision of the third gap D3 can reduce the effective area of the first touch electrode 11 and/or the second touch electrode 12, which is conducive to reducing the parasitic capacitance between the touch unit 100 and the display electrode, thereby being conducive to reducing the load of the display electrode during operation. Meanwhile, by arranging the second dummy electrode 22 to cover the third gap D3, when the display panel 01 displays an image, the second dummy electrode 22 can block the light leakage in the third gap D3, which is conducive to avoiding the problem of the visibility of the third gap D3 in the displayed image, thereby being conducive to further improving the display quality of the display panel 01.

In one technical solution of the embodiment of the present application, as shown in FIG. 13A and FIG. 13B, the second dummy electrode 22 includes a second sub-portion 22A and a second dummy portion 22B. The second dummy portion 22B is located in a same layer as the first main body electrode 111 and is located in the third gap D3.

As shown in FIG. 13A, a third sub-gap D31 is provided between the second dummy portion 22B and the adjacent first touch electrode 11, and/or, as shown in FIG. 13B, a third sub-gap D31 is provided between the second dummy portion 22B and the adjacent second touch electrode 12.

Exemplarily, as shown in FIGS. 12A and 13A, the second dummy portion 22B may be grid-shaped, and the third sub-gap D31 may be a gap between one trace in the second dummy portion 22B and one trace in the first touch electrode 11. A plurality of third sub-gaps D31 may be provided between the second dummy portion 22B and the adjacent first touch electrode 11. Alternatively, as shown in FIGS. 12B and 13B, the third sub-gap D31 is a gap between one trace in the second dummy portion 22B and one trace in the second touch electrode 12. A plurality of third sub-gaps D31 may be provided between the second dummy portion 22B and the adjacent second touch electrode 12.

The second sub-portion 22A and the second dummy portion 22B are located in different layers. In the plane view, the second sub-portion 22A covers the third sub-gap D31.

Optionally, the second sub-portion 22A overlaps with at least one of the two traces between which the third sub-gap D31 is provided, so as to ensure the reliability of the second sub-portion 22A covering the third sub-gap D31.

In this technical solution, by arranging the second dummy portion 22B to be in the same layer as the first main body electrode 111 and located in the third gap D3 of the first touch electrode 11 and/or the second touch electrode 12, the second dummy portion 22B can fill part of the third gap D3. Meanwhile, by arranging the second sub-portion 22A to cover the third sub-gap D31 between the second dummy portion 22B and the first touch electrode 11 and/or the second touch electrode 12, the second dummy electrode 22 can cover the third gap D3.

Moreover, the size of the third sub-gap D31 is smaller than the size of the third gap D3, which is conducive to reducing the process difficulty of the second sub-portion 22A covering the third sub-gap D31.

Optionally, the second sub-portion 22A is in the same layer as the first connection portion 112. As such, the second sub-portion 22A can be manufactured using the same process and material as the first connection portion 112, which neither requires adding an additional process for manufacturing the second sub-portion 22A nor increases the thickness of the display panel 01.

In one implementation of this technical solution, as shown in FIGS. 13A and 13B, a first insulating layer JC is provided between the second sub-portion 22A and the second dummy portion 22B. The first insulating layer JC includes a second through hole K2, and the second sub-portion 22A is connected to the second dummy portion 22B through the second through hole K2.

Optionally, as shown in FIGS. 12A and 12B, the display panel 01 further includes a plurality of sub-pixels PX. The second dummy portion 22B includes a plurality of third type-A traces SL3 and a plurality of third type-B traces XL3 that are connected, and a extending direction of the third type-A traces SL3 intersects with a extending direction of the third type-B traces XL3.

The plurality of third type-A traces SL3 and the plurality of third type-B traces XL3 cross to define at least one third dummy grid WG3. In the plane view, the third dummy grid WG3 encloses at least one sub-pixel PX. The second through hole K2 is located at the intersection of the third dummy grid WG3.

Based on this arrangement, in the plane view, there is no overlap between the second dummy portion 22B and the sub-pixels PX, which is conducive to avoiding the second dummy portion 22B blocking the light exiting of the sub-pixels PX. Moreover, the intersections of the third dummy grid WG3 are usually far from the sub-pixels PX they enclose. Arranging the second through hole K2 at the intersections of the third dummy grid WG3 is conducive to reducing the impact of the fabrication of the second through hole K2 on the sub-pixels PX, thereby being conducive to reducing the impact of the fabrication of the second through hole K2 on the display effect.

Optionally, as shown in FIGS. 12A and 12B, in the plane view, the second sub-portion 22A overlaps with the second dummy portion 22B, and a projection of the second sub-portion 22A onto a plane of the second dummy portion 22B is located on the third dummy grid WG3. The second sub-portion 22A may overlap with at least part of the second dummy portion 22B. As such, on one hand, there is no overlap between the second sub-portion 22A and the sub-pixels PX in the plane view, which is conducive to avoiding the second sub-portion 22A blocking the light exiting of the sub-pixels PX; on the other hand, it can reduce the structural complexity of the second dummy electrode 22, thereby being conducive to reducing the manufacturing difficulty of the second dummy electrode 22.

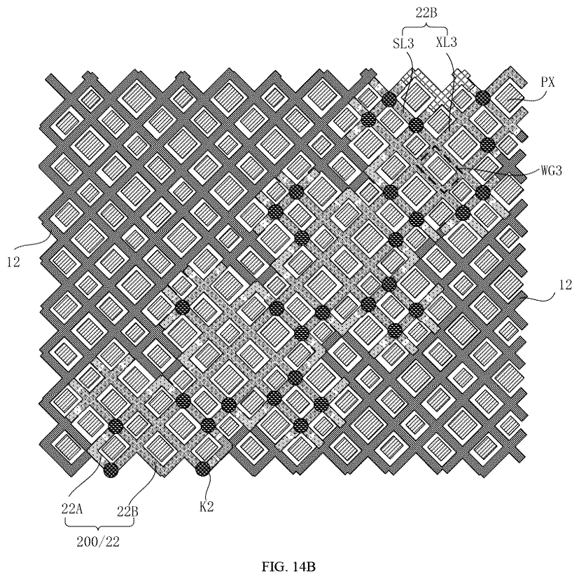

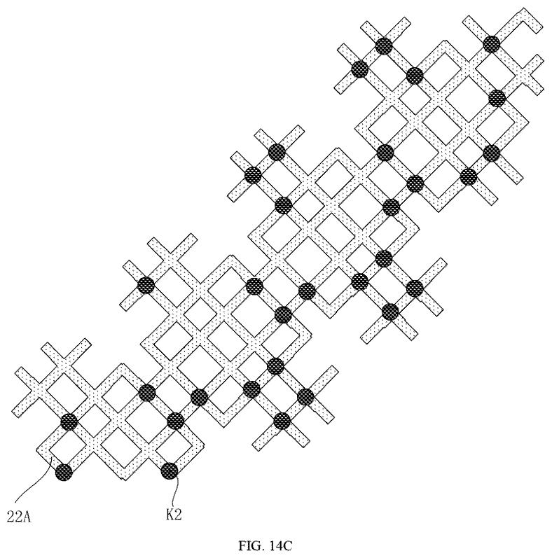

Exemplarily, as shown in FIGS. 14A, 14B, and 14C, FIG. 14A is another enlarged schematic diagram of the region Q3 in FIG. 2, FIG. 14B is another enlarged schematic diagram of the region Q4 in FIG. 2, and FIG. 14C is a schematic diagram of a second sub-portion in FIGS. 14A and 14B. The second dummy electrode 22 includes one second sub-portion 22A, and the second sub-portion 22A is connected to the second dummy portion 22B through at least one second through hole K2. In this case, in the plane view, the projection of the second sub-portion 22A located in the region of the second dummy portion 22B may coincide with the second dummy portion 22B.

Exemplarily, as shown in FIGS. 12A, 12B, and 12C, FIG. 12C is a schematic diagram of the second sub-portion in FIGS. 12A and 12B. The second dummy electrode 22 includes a plurality of second sub-portions 22A, and one second sub-portion 22A is connected to the second dummy portion 22B through at least one second through hole K2. As shown in FIG. 12C, the second sub-portion 22A may be in the shape of “-”, “ [symbol] ”, “ [symbol] ”, or “ [symbol] ”, or a combination of at least two of “-”, “ [symbol] ”, ‘ [symbol] ’, and “ [symbol] ”.

It should be noted that FIG. 12C only illustrates a case where the second sub-portion 22A is in the shape of “ [symbol] ” and “-”, and is connected to the second dummy portion 22B through one or two second through holes K2.

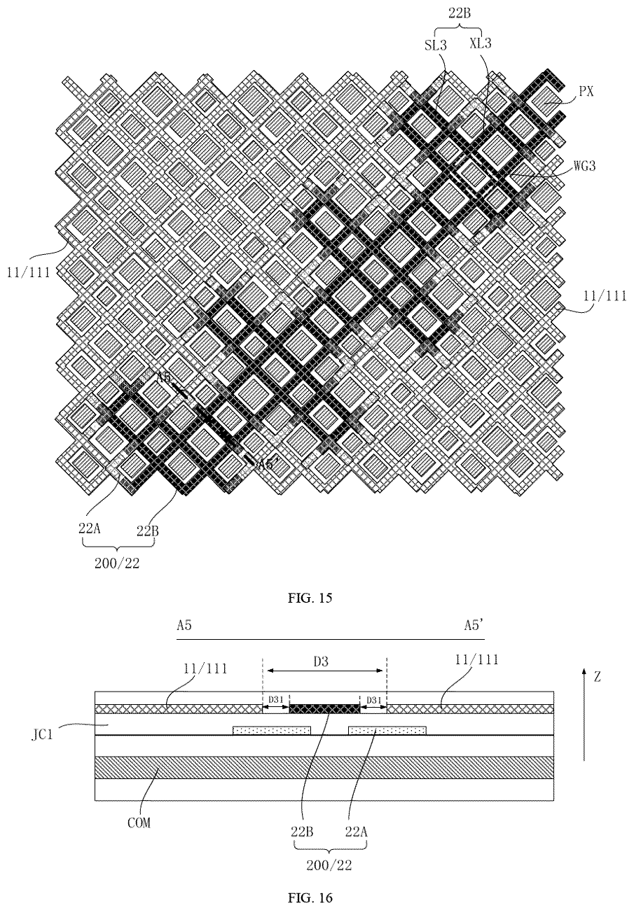

FIG. 15 is another enlarged schematic diagram of the region Q3 in FIG. 2, and FIG. 16 is a cross-sectional schematic diagram taken along a section line A5A5′ in FIG. 15.

In another implementation of this technical solution, as shown in FIGS. 15 and 16, the second sub-portion 22A is separated from the second dummy portion 22B. That is, the second sub-portion 22A and the second dummy portion 22B are located in different layers, and the second sub-portion 22A is not connected to the second dummy portion 22B.

Based on this arrangement, it is not necessary to connect the second sub-portion 22A and the second dummy portion 22B through drilling holes, which is conducive to simplifying the manufacturing process of the second dummy electrode 22 and save costs.

It should be noted that the second dummy electrode 22 in the region Q4 in FIG. 2 may also adopt the structure shown in FIGS. 15 and 16. It should be noted that the first dummy electrode 21 in the region Q1 in FIG. 2 may also adopt the structure shown in FIGS. 15 and 16.

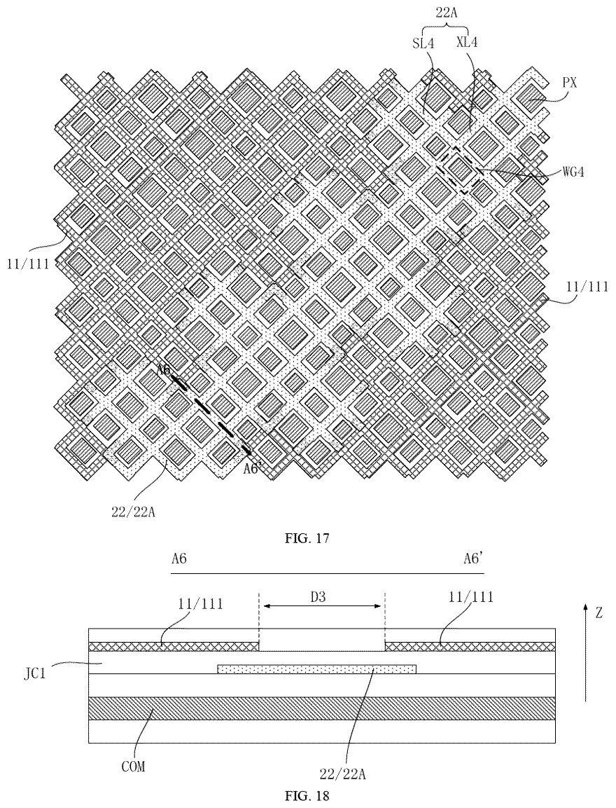

FIG. 17 is another enlarged schematic diagram of the region Q3 in FIG. 2, and FIG. 18 is a cross-sectional schematic diagram taken along a section line A6A6′ in FIG. 17.

In another technical solution of the embodiment of the present application, as shown in FIGS. 17 and 18, the second dummy electrode 22 includes a second sub-portion 22A, and the second sub-portion 22A and the first main body electrode 111 are located in different layers. In the plane view, the second sub-portion 22A covers the third gap D3.

Optionally, in the plane view, the second sub-portion 22A overlaps with at least one of the two traces between which the third gap D3 is provided, so as to improve the reliability of the second sub-portion 22A covering the third gap D3.

In this technical solution, the second dummy electrode 22 is a single-layer structure. By arranging the second sub-portion 22A in the second dummy electrode 22 to cover the third gap D3, the second dummy electrode 22 can cover the third gap D3. Moreover, since the second dummy electrode 22 is a single-layer structure, which is conducive to reducing the structural complexity of the second dummy electrode 22, thereby being conducive to reducing the manufacturing difficulty of the second dummy electrode 22.

Optionally, the second sub-portion 22A is in the same layer as the first connection portion 112. As such, the second sub-portion 22A can be manufactured using the same process and material as the first connection portion 112, which neither requires adding an additional process for manufacturing the second sub-portion 22A nor increases the thickness of the display panel 01.

Optionally, as shown in FIG. 17, the display panel 01 further includes a plurality of sub-pixels PX. The second dummy electrode includes a second sub-portion. The second sub-portion 22A includes a plurality of fourth type-A traces SL4 and a plurality of fourth type-B traces XL4 that are connected, and an extending direction of the fourth type-A traces SL4 intersects with an extending direction of the fourth type-B traces XL4.

The plurality of fourth type-A traces SL4 and the plurality of fourth type-B traces XL4 cross to define at least one fourth dummy grid WG4. In the plane view, the fourth dummy grid WG4 encloses at least one sub-pixel PX.

Based on this arrangement, in the plane view, there is no overlap between the second sub-portion 22A and the sub-pixels PX, that is, there is no overlap between the second dummy electrode 22 and the sub-pixels PX, which is conducive to avoiding the second dummy electrode 22 blocking the light exiting of the sub-pixels PX.

It should be noted that the second dummy electrode 22 in the region Q4 in FIG. 2 may also adopt the structure shown in FIGS. 17 and 18. When both the first touch electrode 11 and the second touch electrode 12 include the third gap D3, the structure of the second dummy electrode 22 covering the third gap D3 in the first touch electrode 11 and the structure of the second dummy electrode 22 covering the third gap D3 in the second touch electrode 12 may be the same or different.

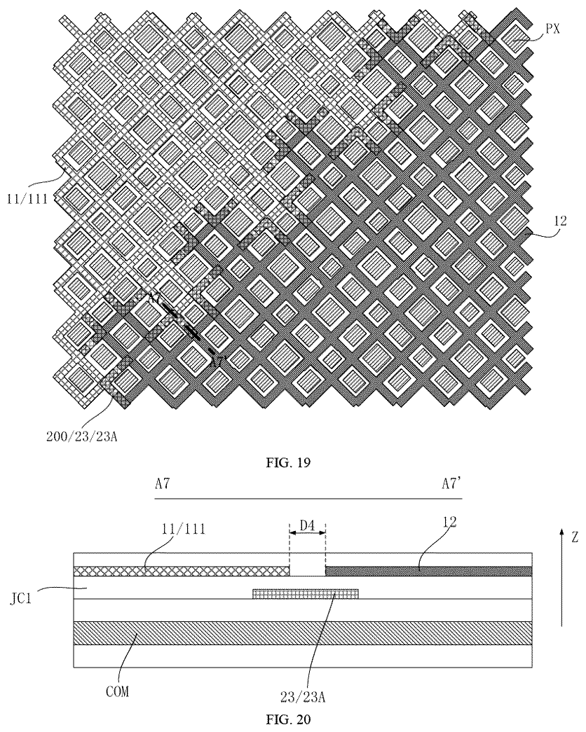

FIG. 19 is an enlarged schematic diagram of a region Q5 in FIG. 2, and FIG. 20 is a cross-sectional schematic diagram taken along a section line A7A7′ in FIG. 19.

In an embodiment of the present application, as shown in FIGS. 2, 19, and 20, a fourth gap D4 is further provided between the first main body electrode 111 and the second touch electrode 12, and a length of the fourth gap D4 is smaller than a side length of one grid in the first main body electrode and the second touch electrode.

Exemplarily, as shown in FIGS. 4A-4B, 5, 19, and 20, both the first main body electrode 111 and the second touch electrode 12 are grid-shaped. The first gap D1 is a gap between one trace in the first main body electrode 111 and one trace in the second touch electrode 12, and the length of the first gap D1 may be greater than the side length of a grid in the first main body electrode 111 and the second touch electrode 12.

The fourth gap D4 is also a gap between one trace in the first main body electrode 111 and one trace in the second touch electrode 12, and the length of the fourth gap D4 is smaller than the side length of a grid in the first main body electrode 111 and the second touch electrode 12. The fourth gap D4 and the first gap D1 may be located at different adjacent positions between the first main body electrode 111 and the second touch electrode 12.

As shown in FIGS. 19 and 20, the dummy electrode 200 further includes a third dummy electrode 23. The third dummy electrode 23 includes a third sub-portion 23A, and the third sub-portion 23A and the first main body electrode 111 are located in different layers. In the plane view, the third sub-portion 23A covers the fourth gap D4 and overlaps with the first main body electrode 111 and/or the second touch electrode 12.

It should be noted that FIGS. 19 and 20 only illustrate a case where the third sub-portion 23A overlaps with the first main body electrode 111 and also overlaps with the second touch electrode 12.

In the embodiment of the present application, by arranging the third sub-portion 23A to cover the fourth gap D4 in the plane view, when the display panel 01 displays an image, the third sub-portion 23A can block the light leakage in the fourth gap D4, which is conducive to avoiding the problem of the visibility of the fourth gap D4 in the displayed image, thereby being conducive to further improving the display quality of the display panel 01.

Meanwhile, by arranging the third sub-portion 23A to overlap with the first main body electrode 111 and/or the second touch electrode 12 in the plane view, it is conducive to avoiding the problem of poor reliability of the third sub-portion 23A covering the fourth gap D4 due to process fluctuations, and is conducive to improving the reliability of the third sub-portion 23A covering the fourth gap D4.

Optionally, the third sub-portion 23A is in the same layer as the first connection portion 112. As such, the third sub-portion 23A can be manufactured using the same process and material as the first connection portion 112, which neither requires adding an additional process for manufacturing the third sub-portion 23A nor increases the thickness of the display panel 01.

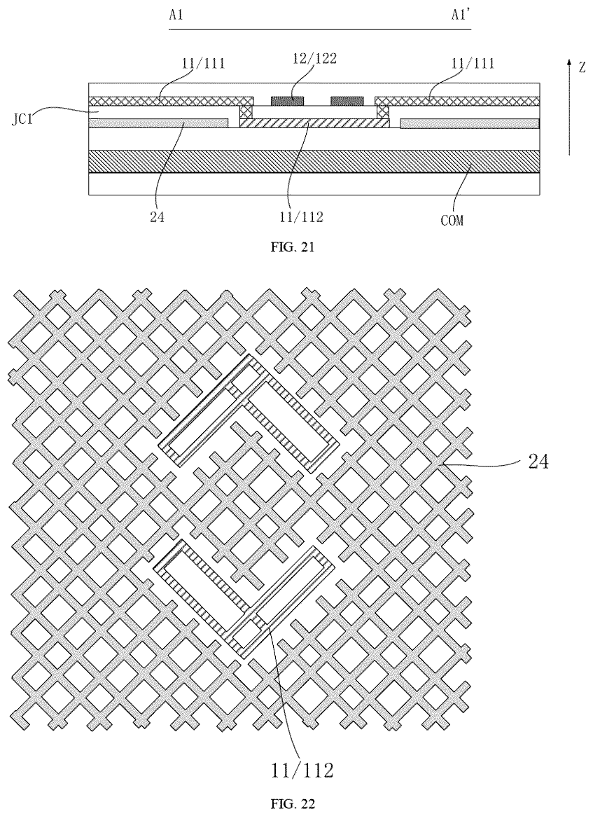

Optionally, the third sub-portion 23A may be in the shape of “-”, “ [symbol] ”, “ [symbol] ”, or “ [symbol] ”, or a combination of at least two of “-”, “ [symbol] ”, ‘ [symbol] ’, and “ [symbol] ”. FIG. 21 is another cross-sectional schematic diagram taken along the section line A1A1′ in FIG. 2, and FIG. 22 is a partially enlarged schematic diagram of a fourth sub-portion according to an embodiment of the present application.

In an embodiment of the present application, as shown in FIG. 21, the display panel 01 further includes a fourth sub-portion 24A. The fourth sub-portion 24A is in a same layer as the first connection portion 112 and is electrically insulated from the first connection portion 112. That is, the fourth sub-portion 24A may be located between the display cathode COM of the display panel 01 and the first main body electrode 111.

As shown in FIGS. 22 and 5, the fourth sub-portion 24A, the first main body electrode 111, and the second touch electrode 12 are all grid-shaped. In the plane view, a grid-shape of the fourth sub-portion 24A overlaps at least partially with the first main body electrode 111 and the second touch electrode 12.

Optionally, the part of the fourth sub-portion 24A located in the region of the first main body electrode 111 has a same shape as the first main body electrode 111, and the part of the fourth sub-portion 24A located in the region of the second touch electrode 12 has a same shape as the second touch electrode 12.

Further, the fourth sub-portion 24A may extend to the edge of the display area of the display panel 01.

Herein, the fourth sub-portion 24A receives a fixed potential signal. Exemplarily, the fixed potential signal may be a power supply voltage signal, a ground signal, a reset signal, or other constant voltage signals.

In the embodiment of the present application, the fourth sub-portion 24A is located between the first main body electrode 111, the second touch electrode 12, and the display cathode COM of the display panel 01, and the fourth sub-portion 24A receives a fixed potential signal. Thus, the fourth sub-portion 24A can serve as a shield, which is conducive to reducing mutual interference between touch signals and display signals.

In an embodiment of the present application, as shown in FIGS. 7 and 8, the first dummy electrode 21 includes a first sub-portion 21A, and the first sub-portion 21A is in a same layer as the first connection portion 112. In the plane view, the first sub-portion 21A covers the first gap D1, and the first sub-portion 21A overlaps with the first main body electrode 111 and/or the second touch electrode 12.

As shown in FIGS. 17 and 18, both the first touch electrode 11 and the second touch electrode 12 are grid-shaped. The first touch electrode 11 and/or the second touch electrode 12 includes a third gap D3, and the length of the third gap D3 is greater than the side length of a grid in the first touch electrode 11 and the second touch electrode 12. The dummy electrode 200 further includes a second dummy electrode 22, and the second dummy electrode 22 includes a second sub-portion 22A. The second sub-portion 22A is in a same layer as the first connection portion 112. In the plane view, the second sub-portion 22A covers the third gap D3.

As shown in FIGS. 19 and 20, a fourth gap D4 is further provided between the first main body electrode 111 and the second touch electrode 12, and a length of the fourth gap D4 is smaller than a side length of one grid. The dummy electrode 200 further includes a third dummy electrode 23, and the third dummy electrode 23 includes a third sub-portion 23A. The third sub-portion 23A is in a same layer as the first connection portion 112. In the plane view, the third sub-portion 23A covers the fourth gap D4 and overlaps with the first main body electrode 111 and/or the second touch electrode 12.

As shown in FIG. 22, at least one of the first sub-portion 21A, the second sub-portion 22A, and the third sub-portion 23A is integrally provided with the fourth sub-portion 24A. That is, at least one of the first sub-portion 21A, the second sub-portion 22A, and the third sub-portion 23A is manufactured using the same material and process as the fourth sub-portion 24A and connected to each other.

For example, the fourth sub-portion 24A may be connected to the second sub-portion 22A and the third sub-portion 23A, but disconnected from the first sub-portion 21A and the first connection portion 112.

For example, the fourth sub-portion 24A may be connected to the third sub-portion 23A, but disconnected from the first sub-portion 21A, the second sub-portion 22A, and the first connection portion 112.

It should be noted that the integral structure formed by the mutual connection of the first sub-portion 21A, the second sub-portion 22A, the third sub-portion 23A, and the fourth sub-portion 24A may cover the entire display area except for the first connection portion 112, and the integral structure is grid-shaped.

In the embodiment of the present application, the fourth sub-portion 24A may form a shielding layer with a larger area together with at least one of the first sub-portion 21A, the second sub-portion 22A, and the third sub-portion 23A, which is conducive to further reducing mutual interference between touch signals and display signals.

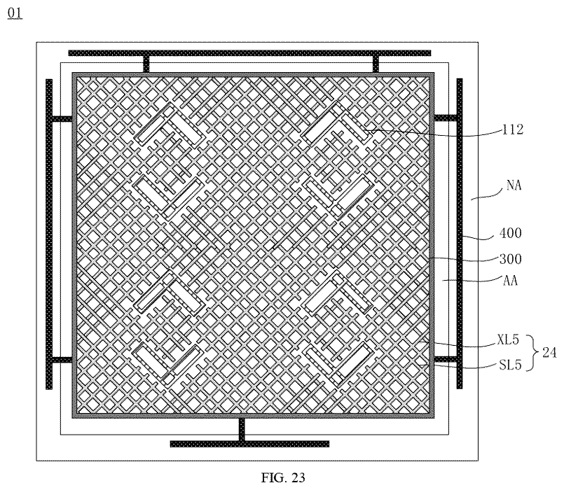

FIG. 23 is a planar schematic diagram of another display panel according to an embodiment of the present application.

In an embodiment of the present application, as shown in FIG. 23, the display panel 01 includes a display area AA and a bezel area NA surrounding the display area AA, and the fourth sub-portion 24 is located in the display area AA.

In the display area AA, the fourth sub-portion 24 may be connected to the first sub-portion 21A, the second sub-portion 22A, and the third sub-portion 23A. An entire surface structure excluding the position where the first connection portion 112 is located is formed in the display area AA, and the entire surface structure is grid-shaped. For convenience of description, in FIG. 23, the integral structure formed by connecting the first sub-portion 21A, the second sub-portion 22A, the third sub-portion 23A, and the fourth sub-portion 24 is collectively referred to as the fourth sub-portion 24 for illustration.

The fourth sub-portion 24 includes a plurality of fifth type-A traces SL5 and a plurality of fifth type-B traces XL5 that electrically connected, and an extending direction of the fifth type-A traces SL5 intersects with an extending direction of the fifth type-B traces XL5.

A metal pad layer 300 is provided on a side of the fourth sub-portion 24 close to the edge of the display panel 01, and at least part of the fifth type-A traces SL5 and the fifth type-B traces XL5 are electrically connected to the metal pad layer 300. The fourth sub-portion 24 receives a fixed potential signal through the metal pad layer 300.

In the embodiment of the present application, arranging the grid-shaped fourth sub-portion 24 to receive the fixed potential signal through the metal pad layer 300 can reduce the transmission loss of the fixed potential signal, which is conducive to saving power consumption.

Exemplarily, as shown in FIG. 23, the display panel 01 further includes a fixed potential signal line 400, and the fixed potential signal line 400 is configured to transmit the fixed potential signal required by the fourth sub-portion 24. The fixed potential signal line 400 may be located in the bezel area NA, and the fixed potential signal line 400 is electrically connected to the metal pad layer 300 through the bezel area NA.

Optionally, the fixed potential signal line 400 surrounds the display area AA, and the metal pad layer 300 surrounds the fourth sub-portion 24. The fixed potential signal line 400 may be electrically connected to the metal pad layer 300 from different sides of the display area AA, so as to further reduce the transmission loss of the fixed potential signal.

Exemplarily, as shown in FIG. 23, the fixed potential signal line 400 may surround the display area AA in a non-closed manner, so as to avoid mutual interference between the fixed potential signal line 400 and other traces in the bezel area NA.

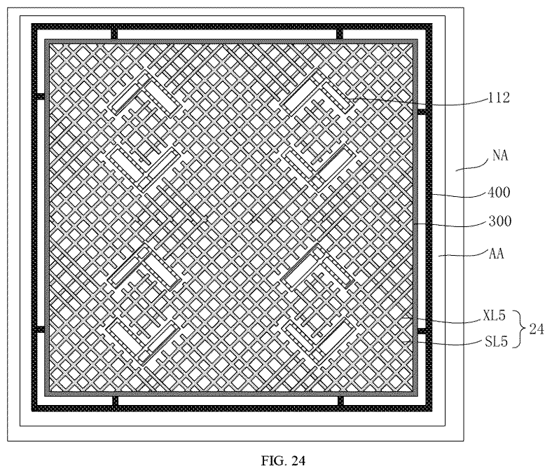

Exemplarily, as shown in FIG. 24, FIG. 24 is a planar schematic diagram of another display panel according to an embodiment of the present application. The fixed potential signal line 400 is located at a position close to the edge in the display area AA, and the fixed potential signal line 400 surrounds the fourth sub-portion 24.

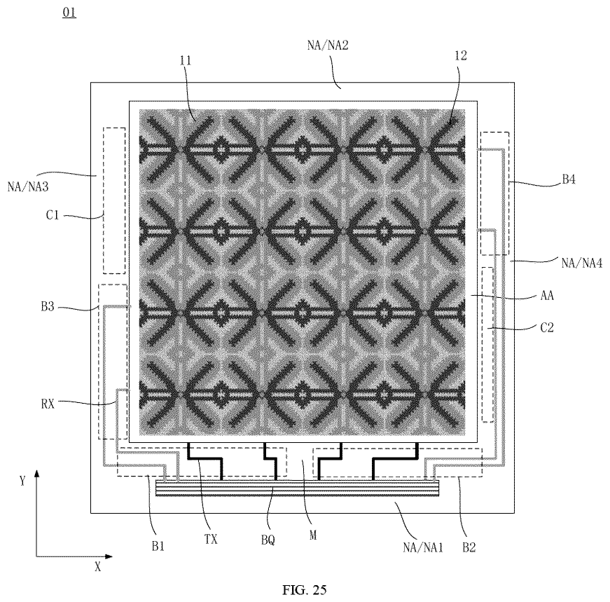

FIG. 25 is a planar schematic diagram of another display panel according to an embodiment of the present application.

In an embodiment of the present application, as shown in FIG. 25, the bezel area NA includes a first bezel area NA1 and a second bezel area NA2 located on opposite sides of the display area AA. The first bezel area NA1 includes a bonding area BQ, and the bonding area BQ is configured to bond a control chip (not shown in the figure). The first bezel area NA1 and the second bezel area NA2 are arranged along a second direction Y.

The bezel area NA further includes a third bezel area NA3 and a fourth bezel area NA4 located on opposite sides of the display area AA. The third bezel area NA3 and the fourth bezel area NA4 are arranged along a third direction X, and the second direction Y intersects with the third direction X.

Exemplarily, the second direction Y is the column direction of the display panel 01, and the third direction X is the row direction of the display panel 01. The first bezel area NA1 is the “lower” bezel of the display panel 01, the second bezel area NA2 is the “upper” bezel of the display panel 01, the third bezel area NA3 is the “left” bezel of the display panel 01, and the fourth bezel area NA4 is the “right” bezel of the display panel 01.

The display panel 01 further includes first touch signal lines TX and second touch signal lines RX. The first touch signal lines TX are electrically connected to the first touch electrodes 11 (the connection structure is not shown), and the second touch signal lines RX are electrically connected to the second touch electrodes 12 (the connection structure is not shown).

Herein, the first touch signal lines TX are located in the first bezel area NA1 and are electrically connected to the first touch electrodes 11 through the first bezel area NA1. Part of the second touch signal lines RX extend from the first bezel area NA1 to the third bezel area NA3 and are electrically connected to the second touch electrodes 12 through the third bezel area NA3. Part of the second touch signal lines RX extend from the first bezel area NA to the fourth bezel area NA4 and are electrically connected to the second touch electrodes 12 through the fourth bezel area NA4.

Optionally, as shown in FIG. 25, the first bezel area NA1 includes a first wiring area B1 and a second wiring area B2 where the first touch signal lines TX are arranged. The first wiring area B1 and the second wiring area B2 are arranged along the third direction X. For the first touch signal lines TX located in the first bezel area NA1, part of the first touch signal lines TX pass through the first wiring area B1, and the other part of the first touch signal lines TX pass through the second wiring area B2.

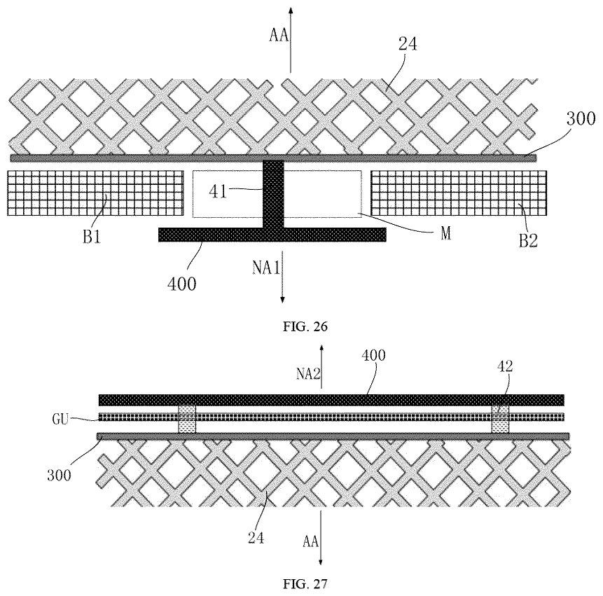

As shown in FIG. 26, FIG. 26 is a partially enlarged schematic diagram of a first bezel area in FIG. 25. A gap M is provided between the first wiring area B1 and the second wiring area B2, and the fixed potential signal line 400 is electrically connected to the metal pad layer 300 through the gap M. That is, the connection trace 41 between the fixed potential signal line 400 and the metal pad layer 300 passes through the gap M.

Based on this arrangement, the connection trace 41 between the fixed potential signal line 400 and the metal pad layer 300 is relatively easy to fabricate, which can reduce the arrangement interference between the connection trace 41 and the first touch signal lines TX.

It should be noted that in some cases, in the first bezel area NA1, some traces extending along the third direction X may be further provided between the fixed potential signal line 400 and the metal pad layer 300, such as protection lines, dummy lines, etc., and these traces may be disconnected at the gap M.

Optionally, as shown in FIGS. 25 and 27, FIG. 27 is a partially enlarged schematic diagram of a second bezel area in FIG. 25. The fixed potential signal line 400 is electrically connected to the metal pad layer 300 through the second bezel area NA2. In the second bezel area NA2, the fixed potential signal line 400 is electrically connected to the metal pad layer 300 through a bridge structure 42.

After research, the inventors of the present application found that in the second bezel area NA2, a protection line GU extending along the third direction X is usually arranged between the fixed potential signal line 400 and the metal pad layer 300, and the protection line GU usually cannot be completely disconnected in the second bezel area NA2. Therefore, the bridge structure 42 is arranged to cross over the protection line GU to realize the electrical connection between the fixed potential signal line 400 and the metal pad layer 300.

Of course, in the second bezel area NA2, if other traces extending along the third direction X are further arranged between the fixed potential signal line 400 and the metal pad layer 300, the bridge structure 42 can cross over them together.

Optionally, as shown in FIG. 25, the third bezel area NA3 includes a third wiring area B3 where the second touch signal lines RX are arranged, and a first area C1 located on one side of the third wiring area B3. The third wiring area B3 and the first area C1 are arranged along the second direction Y.

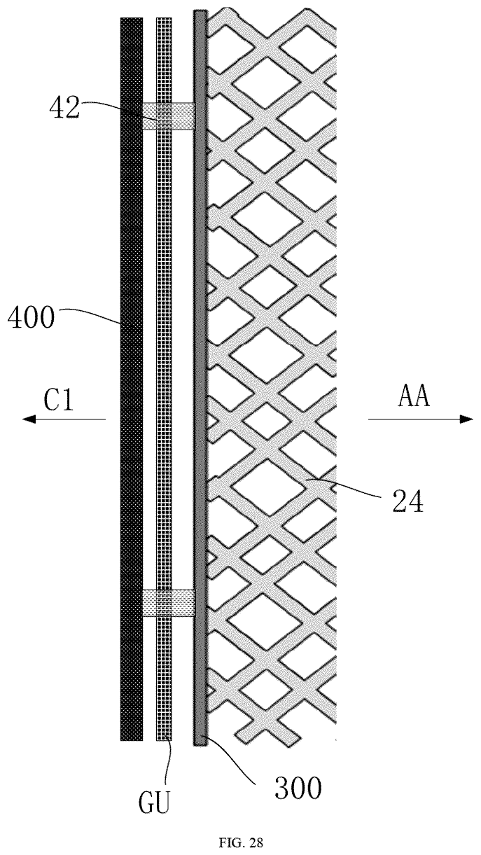

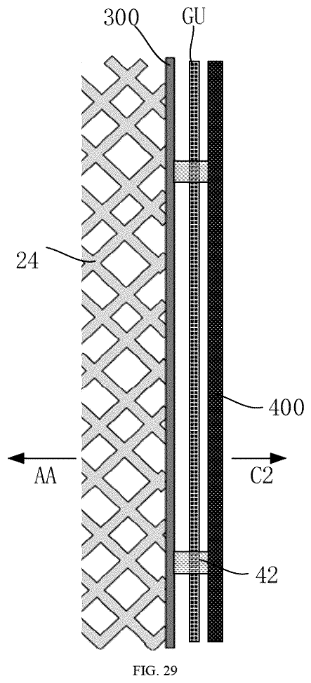

As shown in FIG. 28, FIG. 28 is a partially enlarged schematic diagram of a first area in FIG. 25. The fixed potential signal line 400 is electrically connected to the metal pad layer 300 through the first area C1.

Exemplarily, as shown in FIG. 28, the first area C1 includes a protection line GU extending along the second direction Y. In the first area C1, the fixed potential signal line 400 is electrically connected to the metal pad layer 300 through the bridge structure 42 crossing over the protection line GU.

Of course, in the first area C1, if other traces extending along the second direction Y are further arranged between the fixed potential signal line 400 and the metal pad layer 300, the bridge structure 42 can cross over them together.

Optionally, as shown in FIG. 25, the fourth bezel area NA4 includes a fourth wiring area B4 where the second touch signal lines RX are arranged, and a second area C2 located on one side of the fourth wiring area B4. The fourth wiring area B4 and the second area C2 are arranged along the second direction Y.

As shown in FIG. 29, FIG. 29 is a partially enlarged schematic diagram of a second area in FIG. 25. The fixed potential signal line 400 is electrically connected to the metal pad layer 300 through the second area C2.

Exemplarily, as shown in FIG. 29, the second area C2 includes a protection line GU extending along the second direction Y. In the second area C2, the fixed potential signal line 400 is electrically connected to the metal pad layer 300 through the bridge structure 42 crossing over the protection line GU.

Of course, in the second area C2, if other traces extending along the second direction Y are further arranged between the fixed potential signal line 400 and the metal pad layer 300, the bridge structure 42 can cross over them together.

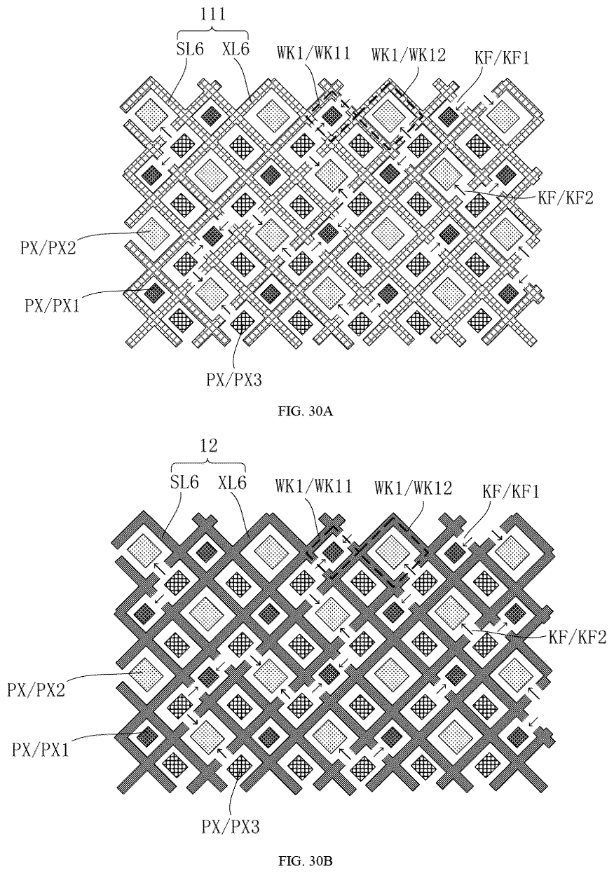

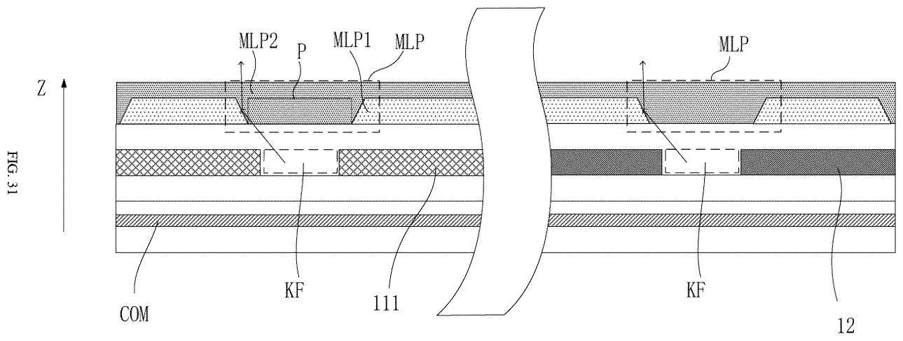

FIG. 30A is a partially enlarged schematic diagram of a first main body electrode according to an embodiment of the present application, and FIG. 30B is a partially enlarged schematic diagram of a second touch electrode according to an embodiment of the present application.

In an embodiment of the present application, as shown in FIGS. 30A and 30B, both the first main body electrode 111 and the second touch electrode 12 are grid-shaped. The display panel 01 further includes a plurality of sub-pixels PX. Both the first main body electrode 111 and the second touch electrode 12 include sixth type-A traces SL6 and sixth type-B traces XL6 that extend in intersecting directions and are electrically connected. The sixth type-A traces SL6 and the sixth type-B traces XL6 cross to define at least one first grid WK1, and the first grid WK1 surrounds at least one sub-pixel PX.

Exemplarily, as shown in FIGS. 30A and 30B, one first grid WK1 surrounds one sub-pixel PX.

The plurality of sub-pixels PX include first color sub-pixels PX1 and second color sub-pixels PX2. The first grid WK1 includes first sub-grids WK11 surrounding the first color sub-pixels PX1 and second sub-grids WK12 surrounding the second color sub-pixels PX2. That is, the first grid WK1 surrounding the first color sub-pixel PX1 may be the first sub-grid WK11, and the first grid WK1 surrounding the second color sub-pixel PX2 may be the second sub-grid WK12.

Optionally, the first color sub-pixels PX1 are red sub-pixels, and the second color sub-pixels PX2 are blue sub-pixels. In addition, as shown in FIGS. 30A and 30B, the sub-pixels PX further include third color sub-pixels PX3. The third color sub-pixels PX3 are arranged adjacent to the first color sub-pixels PX1 and the second color sub-pixels PX2, and the third color sub-pixels PX3 are green sub-pixels.

At least part of the first sub-grids WK11 include first slits KF1. The first slits KF1 may be located on the sides of the first sub-grids WK11, and a length of the first slit KF1 is smaller than a side length of the first sub-grid WK11. Herein, the length of the first slit KF1 refers to the length of the first slit KF1 along the extending direction of the side of the first sub-grid WK11 where it is located.

In different first sub-grids WK11, the orientations of the first slits KF1 are the same. Herein, “the orientations of the first slits KF1 are the same” means that the directions in which the respective first slits KF1 point to the first color sub-pixels PX1 surrounded by the first sub-grids WK11 where they are located are parallel to each other.

At least part of the second sub-grids WK12 include second slits KF2. The second slits KF2 may be located on the sides of the second sub-grids WK12, and a length of the second slit KF2 is smaller than a side length of the second sub-grid WK12. Herein, the length of the second slit KF2 refers to the length of the second slit KF2 along the extending direction of the side of the second sub-grid WK12 where it is located.

In different second sub-grids WK12, the orientations of the second slits KF2 are the same. Herein, “the orientations of the second slits KF2 are the same” means that the directions in which the respective second slits KF2 point to the second color sub-pixels PX2 surrounded by the second sub-grids WK12 where they are located are parallel to each other.

In the embodiment of the present application, arranging the orientations of the first slits KF1 to be the same and the orientations of the second slits KF2 to be the same is conducive to improving the problem of moiré patterns observed under a large viewing angle, thereby being conducive to improving the display quality of the display panel 01.

Optionally, as shown in FIGS. 30A and 30B, the orientation of the first slits KF1 intersects with the orientation of the second slits KF2. That is, the directions in which the first slits KF1 point to the first color sub-pixels PX1 surrounded by the first sub-grids WK11 where they are located intersect with the directions in which the second slits KF2 point to the second color sub-pixels PX2 surrounded by the second sub-grids WK12 where they are located.

Further, the orientations of the first slits KF1 are perpendicular to the orientations of the second slits KF2.

Based on this arrangement, it is conducive to further improving the problem of moiré patterns observed under a large viewing angle.

It should be noted that in the present application, the extending directions of the first type-A traces SL1, the second type-A traces SL2, the third type-A traces SL3, the fourth type-A traces SL4, the fifth type-A traces SL5, and the sixth type-A traces SL6 described in the respective embodiments may be the same; and the extending directions of the first type-B traces XL1, the second type-B traces XL2, the third type-B traces XL3, the fourth type-B traces XL4, the fifth type-B traces XL5, and the sixth type-B traces XL6 described in the respective embodiments may be the same.

In an embodiment of the present application, as shown in FIGS. 30A and 30B, both the first main body electrode 111 and the second touch electrode 12 are grid-shaped. At least one of the first main body electrode 111 and the second touch electrode 12 includes slits KF, and the length of the slit KF is smaller than the side length of a grid. FIG. 30A illustrates a case where the first main body electrode 111 includes the slits KF, and FIG. 30B illustrates a case where the second touch electrode 12 includes the slits KF.

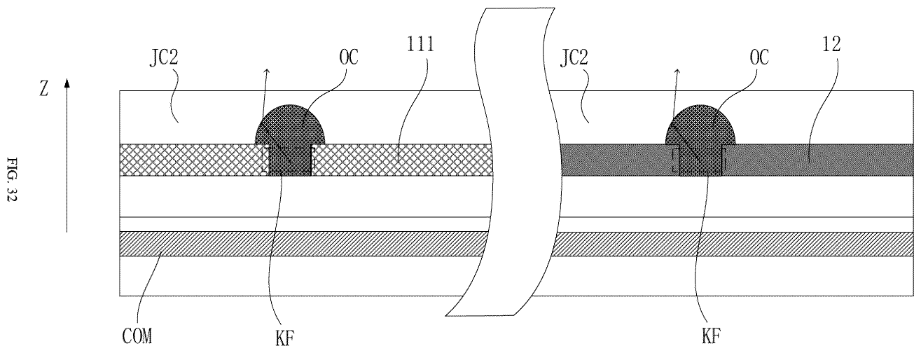

As shown in FIG. 31, FIG. 31 is a partial structural schematic diagram of a display panel according to an embodiment of the present application. The display panel 01 further includes a light extraction structure MLP located on a side of the slit KF facing the light-exiting surface of the display panel 01, and the light extraction structure MLP covers the slit KF.

Herein, the light extraction structure MLP includes a first layer MLP1 and a second layer MLP2 with different refractive indices, and the light extraction structure MLP is configured to convert large-angle light into small-angle light for exiting.

Exemplarily, as shown in FIG. 31, the first layer MLP1 includes openings P, and the openings P overlap with the slits KF in the plane view. The second layer MLP2 covers the first layer MLP1, and a refractive index of the second layer MLP2 is greater than a refractive index of the first layer MLP1.

It can be understood that the second layer MLP2 may fill the openings P of the first layer MLP1.

In the embodiment of the present application, since the refractive index of the first layer MLP1 is smaller than the refractive index of the second layer MLP2, the large-angle light exited from the slits KF can be converted into light with a smaller angle and exited after passing through the light extraction structure MLP, which can reduce the large-angle light exited from the slits KF, which is conducive to alleviating the problem of moiré patterns observed under a large viewing angle caused by the large-angle light exiting from the slits KF, thereby being conducive to improving the display quality of the display panel 01.

In an embodiment of the present application, as shown in FIGS. 30A and 30B, both the first main body electrode 111 and the second touch electrode 12 are grid-shaped. At least one of the first main body electrode 111 and the second touch electrode 12 includes slits KF, and a length of the slit KF is smaller than the side length of a grid. FIG. 30A illustrates a case where the first main body electrode 111 includes the slits KF, and FIG. 30B illustrates a case where the second touch electrode 12 includes the slits KF.

As shown in FIG. 32, FIG. 32 is a partial structural schematic diagram of another display panel according to an embodiment of the present application. The display panel 01 further includes microlens structures OC, and the microlens structures OC cover the slits KF.

Exemplarily, the microlens structures OC protrude toward the side away from the slits KF. The display panel 01 further includes a second insulating layer JC2 covering the microlens structures OC, and a refractive index of the microlens structures OC is greater than a refractive index of the second insulating layer JC2.

In the embodiment of the present application, the large-angle light exited from the slits KF can be converted into light with a smaller angle and exited after passing through the microlens structures OC, which can reduce the large-angle light exited from the slits KF, which is conducive to alleviating the problem of moiré patterns observed under a large viewing angle caused by the large-angle light exiting from the slits KF, thereby being conducive to improving the display quality of the display panel 01.

In an embodiment of the present application, as shown in FIGS. 5, 6, and 7, the first touch electrode 11, the second touch electrode 12, and the first dummy electrode 21 are all grid-shaped, and no slits are provided in the grids of the first touch electrode 11, the second touch electrode 12, and the first dummy electrode 21. Herein, the “slit” refers to a gap whose length is smaller than the side length of a grid, such as the slits KF in FIGS. 30A and 30B.

In the embodiment of the present application, no slits are provided in the grids of the first touch electrode 11, the second touch electrode 12, and the first dummy electrode 21, which is conducive to avoiding the problem of large-viewing-angle moiré patterns caused by the slits, thereby being conducive to further improving the display quality of the display panel 01.

An embodiment of the present application provides a display panel 01. As shown in FIG. 1, the display panel 01 includes a plurality of touch units 100. Each touch unit 100 includes a first touch electrode 11 and a second touch electrode 12, and the first touch electrode 11 is electrically insulated from the second touch electrode 12.

In the display panel 01, the touch units 100 may be arranged in an array along a row direction and a column direction. For the plurality of touch units 100 arranged along the column direction, the first touch electrodes 11 in each touch unit 100 may be electrically connected in sequence; and for the plurality of touch units 100 arranged along the row direction, the second touch electrodes 12 in each touch unit 100 may be electrically connected in sequence. When a user touches the display panel 01, a control system can calculate the coordinates of the touch point according to the magnitude of the mutual capacitance between the first touch electrode 11 and the second touch electrode 12 in the touch unit 100.

As shown in FIG. 2, the first touch electrode 11 includes a first main body electrode 111 and a first connection portion 112. In a same first touch electrode 11, two adjacent first main body electrodes 111 are electrically connected through the first connection portion 112.

Exemplarily, as shown in FIG. 2, one first touch electrode 11 may include two first main body electrodes 111 and a first connection portion 112 connecting the two first main body electrodes 111.

The second touch electrode 12 includes a second main body electrode 121 and a second connection portion 122. In a same second touch electrode 12, two adjacent second main body electrodes 121 are electrically connected through the second connection portion 122.

Exemplarily, as shown in FIG. 2, one second touch electrode 12 may include two second main body electrodes 121 and a second connection portion 122 connecting the two second main body electrodes 121.

As shown in FIGS. 21 and 22, the first connection portion 112 overlaps with the second touch electrode 12 in the plane view.

Exemplarily, the second main body electrode 121 and the second connection portion 122 are in a same layer, the first main body electrode 111 and the second touch electrode 12 are in a same layer, and the first connection portion 112 and the second touch electrode 12 are located in different layers. That is, the first main body electrode 111 and the first connection portion 112 are located in different layers.

The first connection portion 112 is located between the first main body electrode 111 and a display cathode COM. The display panel 01 further includes a fourth sub-portion 24, and the fourth sub-portion 24 and the first connection portion 112 are in a same layer. The fourth sub-portion 24 is grid-shaped.

Exemplarily, as shown in FIGS. 5, 21, and 22, both the first main body electrode 111 and the second touch electrode 12 are grid-shaped. In a plane view, a grid-shape of the fourth sub-portion 24 overlap at least partially with grid-shapes of the first main body electrode 111 and the second touch electrode 12. It should be noted that FIG. 21 only illustrates a case where the fourth sub-portion 24 overlaps with the first main body electrode 111.

Herein, the fourth sub-portion 24 receives a fixed potential signal.

In the embodiment of the present application, the fourth sub-portion 24 is located between the first main body electrode 111 and the display cathode COM of the display panel 01, and the fourth sub-portion 24 receives a fixed potential signal. Thus, the fourth sub-portion 24 can serve as a shield, which is conducive to reducing mutual interference between touch signals and display signals. Moreover, the grid-shaped fourth sub-portion 24 may have no overlap with the sub-pixels in the display panel 01, avoiding the fourth sub-portion 24 affecting the normal display of the display panel 01.

Exemplarily, the display panel 01 according to the present application may further include a polarizer, and the polarizer is provided on a side of the touch unit 100 facing the light-exiting surface of the display panel 01.

Exemplarily, the display panel 01 according to the present application may further include a color filter layer, and the color filter layer is provided on a side of the touch unit 100 facing the light-exiting surface of the display panel 01.

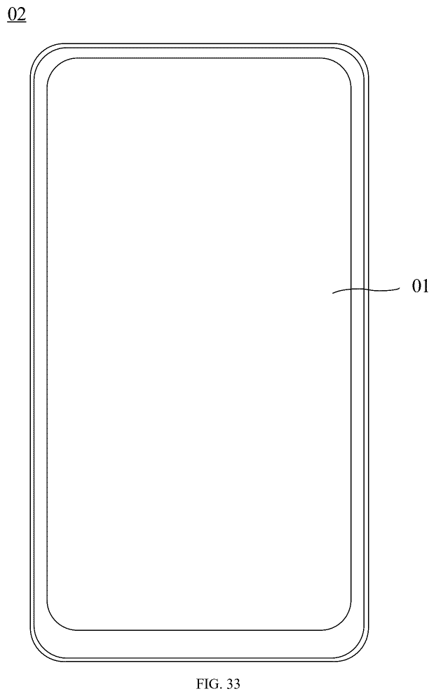

FIG. 33 is a schematic diagram of a display apparatus according to an embodiment of the present application.

An embodiment of the present application provides a display apparatus 02. As shown in FIG. 33, the display apparatus 02 includes the display panel 01 as provided in the above embodiments. Exemplarily, the display apparatus 02 may be an electronic device such as a mobile phone, a computer, a television, a vehicle-mounted display, or a wearable display. The present application does not specifically limit this.

In the display apparatus 02, by arranging the first dummy electrode 21 to cover the first gap D1 in the plane view, when the display panel 01 displays an image, the first dummy electrode 21 can block the light leakage in the first gap D1, which is conducive to avoiding the problem of the visibility of the first gap D1 in the displayed image, thereby being conducive to improving the display quality of the display panel 01.

Meanwhile, by arranging the first dummy electrode 21 to overlap with the first main body electrode 111 and/or the second touch electrode 12 in the plane view, it is conducive to avoiding the problem of poor reliability of the first dummy electrode 21 covering the first gap D1 due to process fluctuations, and is conducive to improving the reliability of the first dummy electrode 21 covering the first gap D1, thereby being conducive to further avoiding the problem of the visibility of the first gap D1 in the displayed image.

The above are merely preferred embodiments of the present application and are not intended to limit the present application. Any modifications, equivalent substitutions, improvements, etc., made within the spirit and principles of the present application shall be included in the protection scope of the present application.

1. A display panel, comprising a plurality of touch units, wherein each of the plurality of touch units comprises a first touch electrode and a second touch electrode, the first touch electrode comprises a first main body electrode and a first connection portion, and in a same first touch electrode, two adjacent first main body electrodes from adjacent ones of the plurality of touch units are electrically connected through the first connection portion; and the first main body electrode and the second touch electrode are located in a same layer, and the first connection portion and the second touch electrode are located in different layers; and
wherein the display panel further comprises a dummy electrode, the dummy electrode comprises a first dummy electrode, a first gap is provided between the first main body electrode and the second touch electrode, and in a plan view, the first dummy electrode covers the first gap and overlaps with the first main body electrode and/or the second touch electrode.

2. The display panel according to claim 1, wherein in the plan view, the first dummy electrode, the first main body electrode, and the second touch electrode form a grid structure;
an orthographic projection of the first dummy electrode onto a plane of the first main body electrode comprises a plurality of first traces forming the grid structure, the first main body electrode comprises a plurality of second traces forming the grid structure, and the second touch electrode comprises a plurality of third traces forming the grid structure;
in the plan view, the first traces overlap with the second traces, and an overlap length between one first trace and one second trace is not greater than a side length of one grid in the grid structure; and/or
in the plan view, the first traces overlap with the third traces, and an overlap length between one first trace and one third trace is not greater than a side length of one grid in the grid structure.

3. The display panel according to claim 1, wherein the first dummy electrode comprises a first sub-portion and a first dummy portion that are connected, the first dummy portion and the first main body electrode are in a same layer, and the first dummy portion is located in the first gap, a first sub-gap is provided between the first dummy portion and the first main body electrode, and a second sub-gap is provided between the first dummy portion and the second touch electrode; and
the first sub-portion and the first dummy portion are located in different layers, and in the plan view, the first sub-portion covers the first sub-gap and the second sub-gap, and the first sub-portion overlaps with the first main body electrode and/or the second touch electrode.

4. The display panel according to claim 3, wherein a first insulating layer is provided between the first sub-portion and the first dummy portion, the first insulating layer comprises a first through hole, and the first sub-portion and the first dummy portion are connected through the first through hole.

5. The display panel according to claim 4, further comprising a plurality of sub-pixels; wherein the first dummy portion comprises a plurality of first type-A traces and a plurality of first type-B traces that are connected, and an extending direction of the first type-A traces intersects with an extending direction of the first type-B traces; and the plurality of first type-A traces and the plurality of first type-B traces cross to define at least one first dummy grid, and in the plan view, the first dummy grid encloses at least one sub-pixel; and
the first through hole is located at an intersection of the first dummy grid.

6. The display panel according to claim 4, wherein the first dummy electrode comprises one first sub-portion, and the first sub-portion is connected to the first dummy portion through at least one first through hole.

7. The display panel according to claim 4, wherein the first dummy electrode comprises a plurality of the first sub-portions, and one first sub-portion is connected to the first dummy portion through at least one first through holes.

8. The display panel according to claim 7, wherein the first sub-portion is in a shape of “-”, “ [symbol] ”, “ [symbol] ”, “ [symbol] ”, or a combination of at least two of “-”, “ [symbol] ”, ‘ [symbol] ’, and “ [symbol] ”.

9. The display panel according to claim 3, wherein the first dummy portion comprises a plurality of first type-A traces and a plurality of first type-B traces that are connected, an extending direction of the first type-A traces intersects with an extending direction of the first type-B traces, and the plurality of first type-A traces and the plurality of first type-B traces cross to define at least one first dummy grid; and
in the plan view, the first sub-portion overlaps with the first dummy portion, and an orthographic projection of the first sub-portion onto a plane of the first dummy portion is located on the first dummy grid.

10. The display panel according to claim 1, wherein the first dummy electrode comprises a first sub-portion, and the first sub-portion and the first main body electrode are located in different layers; and
in the plan view, the first sub-portion covers the first gap, and the first sub-portion overlaps with the first main body electrode and/or the second touch electrode.

11. The display panel according to claim 10, further comprising a plurality of sub-pixels, wherein the first sub-portion comprises a plurality of second type-A traces and a plurality of second type-B traces that are connected, and an extending direction of the second type-A traces intersects with an extending direction of the second type-B traces; the plurality of second type-A traces and the plurality of second type-B traces cross to define at least one second dummy grid, and in the plan view, the second dummy grid encloses at least one sub-pixel.

12. The display panel according to claim 1, wherein a second gap is provided between at least one pair of two adjacent first touch electrodes and two adjacent second touch electrodes, and in the plan view, the first dummy electrode covers the second gap.

13. The display panel according to claim 3, wherein the first sub-portion and the first connection portion are in a same layer.

14. The display panel according to claim 10, wherein the first sub-portion and the first connection portion are in a same layer.

15. The display panel according to claim 1, wherein both the first touch electrode and the second touch electrode are grid-shaped, the first touch electrode and/or the second touch electrode comprise a third gap, and a length of the third gap is greater than a side length of one grid; and
the dummy electrode further comprises a second dummy electrode, and in the plan view, the second dummy electrode covers the third gap.

16. The display panel according to claim 15, wherein the second dummy electrode comprises a second sub-portion and a second dummy portion, and the second dummy portion and the first main body electrode are in a same layer, and the second dummy portion is located in the third gap;
a third sub-gap is provided between the second dummy portion and an adjacent first touch electrode, and/or a third sub-gap is provided between the second dummy portion and an adjacent second touch electrode; and
the second sub-portion and the second dummy portion are located in different layers, and in the plan view, the second sub-portion covers the third sub-gap.

17. The display panel according to claim 16, wherein a first insulating layer is provided between the second sub-portion and the second dummy portion, the first insulating layer comprises a second through hole, and the second sub-portion and the second dummy portion are connected through the second through hole.

18. The display panel according to claim 17, further comprising a plurality of sub-pixels; wherein the second dummy portion comprises a plurality of third type-A traces and a plurality of third type-B traces that are connected, and an extending direction of the third type-A traces intersects with an extending direction of the third type-B traces; the plurality of third type-A traces and the plurality of third type-B traces cross to define at least one third dummy grid, and in the plan view, the third dummy grid encloses at least one sub-pixel; and
the second through hole is located at an intersection of the third dummy grid.

19. The display panel according to claim 17, wherein the second dummy electrode comprises one second sub-portion, and the second sub-portion is connected to the second dummy portion through at least one second through hole.

20. The display panel according to claim 17, wherein the second dummy electrode comprises a plurality of second sub-portions, and one second sub-portion is connected to the second dummy portion through at least one second through hole.

21-53. (canceled)
